(19) United States
(12) Patent Application Publication
(10) Pub. No.: US 2012/0275981 A1
(43) Pub. Date: Nov. 1, 2012

(54) Preparation Of Silicon For Fast Generation Of Hydrogen Through Reaction With Water

(76) Inventors: John Stuart Foord, Oxdford (GB); Sobia Ashraf, Oxford (GB)

(21) Appl. No.: 13/508,150

(22) PCT Filed: Nov. 11, 2010
(86) PCT No.: PCT/GB10/02082

§ 371 Date: Jul. 20, 2012

(30) Foreign Application Priority Data
Nov. 12, 2009 (GB) 0919830.0

(51) Int. Cl. C01B 33/02; B02C 23/06; B02C 23/18; C01B 3/06; B02C 4/36

(52) U.S. Cl. 423/274; 423/348; 423/658.2; 241/30; 241/21; 241/27; 241/15

(57) ABSTRACT

The invention provides a process for producing nonpassivated silicon, which process comprises providing a sample of silicon and, under inert conditions, reducing the mean particle size in the sample by applying a mechanical force to the sample. The invention also provides nonpassivated silicon which is obtainable by such a process, and compositions which comprise the nonpassivated silicon. Further provided is a process for producing hydrogen, which process comprises contacting water with nonpassivated silicon, thereby producing hydrogen by hydrolysis of said silicon. The invention also provides a pellet for generating hydrogen, the pellet comprising nonpassivated silicon encapsulated within an organic coating.

### FIELD OF THE INVENTION

The invention relates to the use of nonpassivated silicon to produce hydrogen, by hydrolysis of the nonpassivated silicon. In particular, the invention relates to a process for producing nonpassivated silicon, a process for producing hydrogen by reacting the nonpassivated silicon with water, and compositions comprising the nonpassivated silicon.

### BACKGROUND TO THE INVENTION

The Hydrogen Economy is a proposed replacement for the current fossil fuel economy, in which renewably produced H₂ is the primary energy carrier. Although hydrogen is energy rich compared to petroleum on a per-weight basis, it is relatively poor on a volumetric basis. Thus if portable hydrogen fuel cells are to be useful, then significant volumes of hydrogen will need to be carried “on-board”, unless high pressure or cryogenic hydrogen storage is used, both of which have significant energy penalties. To address this problem, the physical or chemical confinement of hydrogen, for example within carbon nanotubes or in metal hydrides, has been the subject of a considerable body of research in materials chemistry. Guidelines set out by the US Department of Energy (DOE) target hydrogen storage materials with a hydrogen yield of 9.0 wt % and a specific energy of 10.8 MJ kg⁻¹to be developed by 2015. However the requirements that need to be met by a hydrogen storage material are very demanding; it must both readily absorb and release the gas and be stable over many absorption-discharge cycles.

Some interest is thus now emerging in an alternative approach, which utilises the spontaneous reaction of a material (an “energy carrier”) with a liquid phase, typically an aqueous medium, to generate hydrogen at point of use. To produce a maximum yield on a weight-to-weight basis, light reactive elements are the most suitable, and some possible candidates are compared in Table 1:

TABLE 1
Theoretical hydrogen yields from reaction of light elements with water

| | Element | | | | |
|---|---|---|---|---|---|
| | Li | Na | Mg | Al | Si |
| Wt % H₂ * | 14.0 | 4.3 | 8.2 | 11.1 | 14.24 |
| Specific energy/ | 20.2 | 6.15 | 11.75 | 15.87 | 20.36 |
| MJ kg⁻¹ | | | | | |

(* Wt % yield ratios the mass of hydrogen produced:mass of element consumed)

The spontaneous reaction of alkali metals with water to yield hydrogen is of course well known, and a sodium-based product, where the metal is stabilised to reduce the chemical hazard, is now undergoing commercialisation (Dye, J. L. et al. J. Am. Chem. Soc. 127, 9338-9339, 2005; Shatnawi, M. et al. J. Am. Chem. Soc. 129, 1386-1392, 2007). There are also reports on the hydrolysis of Mg, MgH₂ and aluminium-based alloys with water; however they only produced hydrogen yields of 1.23 wt %, 2.4 wt % and 1.38 wt % respectively, based on the mass of the “energy carrier” compound consumed (Grosjean, M. H., Zidoune, M. & Roué, L. Journal of Alloys and Compounds, 404-406, 712-715, 2005; Grosjean, M. H., Zidoune, M., Roué, L. & Huot, J. Y., International Journal of Hydrogen Energy 31, 109-119, 2006; Grosjean, M.-H. & Roué, L. Journal of Alloys and Compounds 416, 296-302; 2006; Uan, J.-Y., Cho, C.-Y. & Liu, K.-T. International Journal of Hydrogen Energy 32, 2337-2343, 2007; Fan, M.-Q., Xu, F. & Sun, L.-X. International Journal of Hydrogen Energy 32, 2809-2815, 2007; Kravchenko, O. V., Semenenko, K. N., Bulychev, B. M. & Kalmykov, K. B. Journal of Alloys and Compounds 397, 58-62, 2005; Soler, L., Macanas, J., Munoz, M. & Casado, J. in 2nd National Congress on Fuel Cells 144-149, Elsevier Science Bv, Madrid, SPAIN, 2006; Soler, L., Macanás, J., Muñoz, M. & Casado, J., International Journal of Hydrogen Energy 32, 4702-4710, 2007; Wang, H. Z., Leung, D. Y. C., Leung, M. K. H. & Ni, M., Renewable and Sustainable Energy Reviews 13, 845-853, 2009; Zhuk, A. Z., Sheindlin, A. E., Kleymenov, B. V., Shkolnikov, E. I. & Lopatin, M. Y., Journal of Power Sources 157, 921-926, 2006).

In theory, Si is perhaps the element which could best meet the various criteria (Auner, N. & Holl, S., 16th International Conference on Efficiency, Costs, Optimization, and Environmental Impact of Energy Systems 1395-1402, Pergamon-Elsevier Science Ltd, Copenhagen, DENMARK; 2003). The theoretical H₂ yield from its reaction with water, as can be seen in Table 1, is higher than other rival elements. Indeed, silicon has a greater specific energy density than lighter elements such as Al, Mg, Na and Li, as the stoichiometry of the hydrolysis reaction is more favourable. Furthermore, it is an abundant element, comprising (as quartz sand) around 26% of the accessible earth's crust.

In practice, however, silicon is unreactive towards water as its surface is passivated highly efficiently with a native oxide layer upon exposure to air or water (Ozanam, F.; Chazalviel, J. N. Journal of Electroanalytical Chemistry and Interfacial Electrochemistry (1989), 269(2), 251-66). Thermal oxide thicknesses of well below 1 nm can produce this passivation. Carrying out the reaction in strong aqueous base continually dissolves the oxide layer (Sjoberg, S. in 8th International Conference on the Physics of Non-Crystalline Solids 51-57, Elsevier Science Bv, Turku, Finland; 1995), thus enabling the production of hydrogen according to the following reaction:

Si(s)+2NaOH (aq)+H₂O (l)→Na₂SiO₃ (aq)+2H₂ (g) (1)

The use of basic media, however, and the difficulty of disposing of the reaction by-products (which is critical to any mainstream application) seriously detracts environmentally from the use of silicon to generate hydrogen in this way. Sodium hydroxide, for instance, is undesirable because it is corrosive and consequently unsuitable for hydrogen production use in vehicles and household power supplies.

Published patent applications US 2004/0151664 A1 and US 2006/0246001 A1 speculate that hydrogen can be produced by reacting silicon with water, but the problem of oxide passivation is not discussed and no experimental results are provided. Similarly, JP 2007-326742 discusses the production of hydrogen by reacting a “hydrogen-generating substance” with water, and silicon is mentioned in a list of possible reactants. Also, JP 4059691 discusses a reaction between water and finely divided silicon in order to produce hydrogen. These publications do not however address the issue of the highly efficient surface passivation with silicon oxide, or teach how nonpassivated silicon can be isolated for use as an energy carrier. JP 2004-115348 also does not address these issues, but describes a hydrogen generation apparatus. The article J. European Ceramic Society 5 (1989) 219-222, on the other hand, indicates that hydrogen may be produced by vibro-milling silicon in the presence of water at high hydrogen ion concentrations. It does not however suggest how silicon may be isolated in a nonpassivated, reactive form for later use.

Various methods are known for producing more reactive forms of silicon, but the methods or the resulting silicon-containing products are typically unsuitable and/or the resulting silicon remains passivated. U.S. Pat. No. 5,429,866, for instance, discusses the production of silicon powder under fairly impure conditions, by grinding under a mixture of air and nitrogen, with the addition of oil. The resulting silicon remains passivated with a thin layer of silicon oxide. JP 2006100255, on the other hand, describes a process for producing microparticulate silicon for use as an electrode, wherein silicon microparticles are produced and then coated with an outer layer of elemental carbon by chemical vapour deposition. Similarly, JP 2005029410 describes the production of finely divided silicon by jet-milling silicon in dried air, but there is no evidence to support that the resulting product is nonpassivated and able to react with pH-neutral water to produce hydrogen. A further method is described in US 2003/0059361, which concerns the production of reactive silicon particles of reduced particle size by milling. However, the milling is not performed in an inert environment, but in the presence of oxidants, such as water, oxygen and hydroxyl radicals, and the presence of an alcohol such as ethanol is required in order to extract these oxidants. WO 03/025260, on the other hand, describes the preparation of reactive halide-terminated silicon nanocrystals by reducing silicon tetrachloride in organic solvents. The resulting halide-terminated nanocrystals are not suitable for reacting with water to produce hydrogen, but rather for further reaction with an alkyl lithium or Grignard reagent to produce alkyl-terminated particles. Finally, JP 11240709 concerns the production of silicon particles coated with an acid amide rather than nonpassivated silicon.

There is therefore an ongoing need to provide improved materials and reaction systems which address these and other problems, and which can generate hydrogen at point of use towards a target of 9.0 wt % hydrogen in accordance with the DOE Guidelines.

### SUMMARY OF THE INVENTION

The present inventors have found that silicon can be prepared in a reactive form, using a simple process which reduces particle size and increases the reactive surface area of silicon without surface passivation. The resulting “nonpassivated silicon” can be reacted directly with water at low temperatures (<100° C.) to generate hydrogen in accordance with the following reaction:

Si(s)+2H₂O (l)→SiO₂ (s)+2H₂ (g) (2)

Given that silicon normally shows no reaction with water because of highly efficient passivation by thin oxide layers, the inventors initially thought that very high purities and powder dispersions of silicon and rigorous storage conditions would be required in such an application. Surprisingly, however, this was not found to be the case; the present invention uses straightforward laboratory techniques to prepare and preserve nonpassivated silicon, in a process which is amenable to industrial scale-up. Furthermore, the inventors have found that when the nonpassivated silicon is reacted with water to produce hydrogen, the surface passivation of the nonpassivated silicon is not rapid enough to reduce the yield of hydrogen too far below theoretical maximum (14.24 wt % H₂). This was surprising given that thermal oxide thicknesses of well below 1 nm can produce passivation. The yields of hydrogen produced using the nonpassivated silicon of the invention were therefore higher than expected, with yields of up to 9.11 wt % H₂ having been achieved, calculated on a hydrogen:silicon weight ratio. The inventors have therefore provided a viable route for the local generation of hydrogen, through the reaction of nonpassivated silicon with water. Quartz (SiO₂) is generated as the only by-product, which is inert and easily disposed of.

Accordingly, the invention provides a process for producing hydrogen, which process comprises contacting water with nonpassivated silicon, thereby producing hydrogen by hydrolysis of said silicon.

In another aspect, the invention provides a process for producing nonpassivated silicon, which process comprises providing a sample of silicon and, under inert conditions, reducing the mean particle size in the sample by applying a mechanical force to the sample.

In one embodiment, the step of reducing the mean particle size in the sample by applying a mechanical force to the sample comprises milling the sample. The inventors have shown that Si prepared using mechanical milling techniques, which on the industrial scale are used to produce ton quantities of powders, readily reacts with pure water at accessible temperatures to produce hydrogen with good yield.

Accordingly, in one aspect, the invention provides a process for producing nonpassivated silicon, which process comprises providing a sample of silicon and, under inert conditions, milling the sample.

In another aspect, the invention provides a composition which comprises nonpassivated silicon.

The invention further provides nonpassivated silicon which is obtainable by any of the processes of the invention as defined above for producing nonpassivated silicon.

Further provided is the use of nonpassivated silicon to produce hydrogen, by hydrolysis of the nonpassivated silicon.

In another aspect the invention provides a pellet for generating hydrogen, the pellet comprising nonpassivated silicon encapsulated within an organic coating. Typically, the organic coating is suitable for preventing or reducing the ingress of air and moisture, and therefore for preserving the silicon in its nonpassivated form. Yet the coating dissolves, degrades or melts away when the pellet is added to water, thereby exposing the nonpassivated silicon to water such that it can react with the water to produce hydrogen. The coating may for instance have a low melting point such that it melts away when brought into contact with warm or hot water or, for instance, the coating may dissolve in water or degrade when brought into contact with water. In one embodiment, the organic coating is a water-soluble coating.

### BRIEF DESCRIPTION OF THE FIGURES

FIG. 1 shows a scanning electron micrograph (top) and the deduced particle size distribution (bottom) of silicon particles after dry milling at 800 rpm for 15 minutes, as described in Example 1.

FIG. 2 shows a scanning electron micrograph (top) and the deduced particle size distribution (bottom) of silicon particles after dry milling at 800 rpm for 1 hour, as described in Example 1.

FIG. 3 shows a scanning electron micrograph (top) and the deduced particle size distribution (bottom) of silicon particles after dry milling at 800 rpm for 2 hours, as described in Example 1.

FIG. 4 shows a scanning electron micrograph (top) and the deduced particle size distribution (bottom) of silicon particles after dry milling at 600 rpm for 2 hours, as described in Example 1.

FIG. 5 shows a scanning electron micrograph (top) and the deduced particle size distribution (bottom) of silicon particles after dry milling at 1000 rpm for 2 hours, as described in Example 1.

FIG. 6 shows X-ray photoelectron spectra of the samples milled at 800 rpm for durations of 7 minutes (bottom), 15 minutes (middle) and 120 minutes (top). The Si 2p region shows 2 environments corresponding to elemental silicon (99 eV) and SiO₂ (103.5 eV). Experimental data is shown with broken lines and the Gaussian-Lorentzian fits are represented by solid lines.

FIG. 7 shows hydrogen gas evolution profiles recorded at 90° C. for samples milled at 700 rpm for varying times (7 minutes, 15 minutes, 30 minutes, 1 hour and 2 hours), with a high magnification inset showing the initial rate of hydrogen gas evolution in each case. The profiles are plots of the yield of hydrogen (y axis), expressed as a percentage of the theoretical volume of hydrogen produced if all the silicon used in the process is hydrolysed, versus time (x axis) in units of seconds.

FIG. 8 is a graph of the initial rate of silicon hydrolysis recorded at 90° C. (y axis), in units of cm³min⁻¹g⁻¹, versus the milling time of the silicon (x axis) in units of minutes, showing plots for samples milled at speeds of 600 rpm (dashed line, solid diamonds), 700 rpm (solid line, hollow triangles), 800 rpm (solid line, solid triangles), 900 rpm (solid line, solid squares) and 1000 rpm (solid line, solid circles).

FIG. 9 is a graph of the total yield of hydrogen recorded at 90° C. (y axis), expressed as a percentage of the theoretical volume of hydrogen produced if all the silicon used in the process is hydrolysed, versus the milling time of the silicon (x axis) in units of minutes, showing plots for samples milled at speeds of 600 rpm (dashed line, solid diamonds), 700 rpm (dashed line, solid squares), 800 rpm (solid line, solid circles), 900 rpm (solid line, asterisks) and 1000 rpm (solid line, solid triangles).

FIG. 10 is a graph of the initial rate of silicon hydrolysis recorded at 90° C. (y axis), in units of cm³min⁻¹ g⁻¹, versus the milling speed (x axis) in units of rpm, showing plots for samples milled for durations of 7 minutes (dashed line, solid triangles), 15 minutes (solid line, solid circles), 30 minutes (solid line, solid squares), 1 hour (solid line, asterisks) and 2 hours (solid line, solid diamonds).

FIG. 11 compares the hydrogen evolution profiles recorded at 90° C. for samples prepared by wet milling (as described in Example 2) and dry milling (reference) at 700 rpm for 7 minutes. The profiles are plots of the yield of hydrogen (y axis), expressed as a percentage of the theoretical volume of hydrogen produced if all the silicon used in the process is hydrolysed, versus time (x axis) in units of seconds.

FIG. 12 is a graph of the initial rate of silicon hydrolysis recorded at 90° C. (y axis), in units of cm³min⁻g⁻¹, versus the milling speed (x axis) in units of rpm, for silicon particles prepared by wet milling (Example 2; upper line on graph) and dry milling (reference; lower line on graph) for 7 minutes.

FIG. 13 shows a scanning electron micrograph of nonpassivated silicon particles produced by wet milling as described in Example 2.

FIG. 14 shows a scanning electron micrograph of silicon particles produced by wet milling as described in Example 2, after their reaction with water.

FIG. 15 is a graph of the initial rate of hydrolysis of wet-milled silicon recorded at 90° C. (y axis), in units of cm³min⁻¹ g⁻¹, versus the milling time of the silicon (x axis) in units of minutes, showing plots for samples milled at speeds of 600 rpm (grey line, crosses), 700 rpm (dashed line, solid circles), 800 rpm (grey line, solid squares), 900 rpm (solid line, solid triangles) and 1000 rpm (dashed line, solid diamonds).

FIG. 16a is a graph of the initial rate of hydrolysis of wet-milled silicon recorded at 90° C. (y axis), in units of cm³min⁻¹ g⁻¹, versus the milling time of wet-milled silicon (x axis) in units of minutes; samples were wet-milled at a speed of 900 rpm.

FIG. 16b is a graph of the total yield of hydrogen recorded at 90° C. (y axis), expressed as a percentage of the theoretical volume of hydrogen produced if all the silicon used in the process were hydrolysed, versus the milling time of wet-milled silicon (x axis) in units of minutes; samples were wet-milled at a speed of 900 rpm.

FIG. 17 is a graph of the total yield of hydrogen recorded at 90° C. (y axis), expressed as a percentage of the theoretical volume of hydrogen produced if all the silicon used in the process were hydrolysed, versus the milling time of wet-milled silicon (x axis) in units of minutes, showing plots for samples wet-milled at speeds of 600 rpm (grey line, crosses), 700 rpm (dashed line, solid circles), 800 rpm (dashed line, solid diamonds), 900 rpm (grey line, solid squares) and 1000 rpm (solid line, solid triangles).

FIG. 18 is a graph of the initial rate of silicon hydrolysis recorded at 90° C. (y axis), in units of cm³min⁻¹ g⁻¹, versus the wet-milling speed (x axis) in units of rpm, showing plots for samples wet-milled for durations of 2 minutes (grey line, crosses), 3 minutes (dashed line, solid circles), 5 minutes (solid line, solid triangles) and 7 minutes (dashed line, solid diamonds).

FIG. 19 is a graph of the total yield of hydrogen recorded at 90° C. (y axis), expressed as a percentage of the theoretical volume of hydrogen produced if all the silicon used in the process were hydrolysed, versus the wet-milling speed (x axis) in units of rpm, showing plots for samples wet-milled for durations of 2 minutes (grey line, crosses), 3 minutes (dashed line, solid circles), 5 minutes (dashed line, solid diamonds) and 7 minutes (solid line, solid triangles).

FIG. 20 shows typical synchrotron X-ray diffraction data for 3 samples of cubic silicon collected on beam line I11 at the Diamond light source. The plot shows XRD patterns for samples dry milled at 800 rpm for 0.25 hours (lower line), 0.5 hours (middle line) and 1 hour (upper line).

### DETAILED DESCRIPTION OF THE INVENTION

The invention provides a process for producing hydrogen, which process comprises contacting water with nonpassivated silicon, thereby producing hydrogen by hydrolysis of said silicon.

The term “passivate”, as used herein, refers to the process of a material, in this case elemental silicon, becoming passive or unreactive in relation to another material, in this case water, prior to using the materials together. Passivation is typically achieved by the formation of a non-reactive film or layer on the surface of the material, which inhibits the reaction in question, and it may occur spontaneousuly under ambient conditions. Silicon, for instance, is normally unreactive towards water due to highly efficient passivation of the silicon surface by SiO₂ upon exposure to air or moisture; the SiO₂ layer formed can have a thickness of well below 1 nm. Such passivated silicon is not capable of reacting with water to produce hydrogen in accordance with the following reaction:

Si(s)+2H₂O (l)→SiO₂(s)+2H₂ (g)

Accordingly, the term “passivated silicon”, as used herein, refers to silicon that is not capable of reacting with water, at any pH in the range of from 5.5 to 8.5, and at any temperature equal to or less than 100° C., to produce hydrogen.

The invention however relates to the production of nonpassivated silicon, in accordance with the process of the invention as defined above for producing nonpassivated silicon.

The term “nonpassivated silicon” as used herein, refers to silicon that is capable of reacting with water, at a pH of from 5.5 to 8.5, and at a temperature which is equal to or less than 100° C., to produce hydrogen.

It has been found that the nonpassivated silicon produced by the process of the invention is capable of reacting with water at pHs at or close to neutral (pH 7.0), at a temperature which is equal to or less than 100° C., to produce hydrogen. Thus, usually, the nonpassivated silicon produced by the process of the invention, or used in the process of the invention for producing hydrogen, or employed in the compositions or pellets of the invention, is silicon which is capable of reacting with water at a pH of from 6.0 to 8.0, or for instance at a pH of from 6.5 to 7.5, at a temperature which is equal to or less than 100° C., to produce hydrogen. More typically, the nonpassivated silicon referred to herein is capable of reacting with water at a pH of 7 and at a temperature which is equal to or less than 100° C., to produce hydrogen. Even more typically, the nonpassivated silicon is capable of reacting with water at a pH of 7.0 and at a temperature which is equal to or less than 90° C., to produce hydrogen. In one embodiment, the nonpassivated silicon is capable of reacting with water, at a pH of 7, and at a temperature which is equal to or less than 80° C., or, for instance equal to or less than 70° C., or, for instance equal to or less than 60° C., 50° C., 40° C. or 30° C., to produce hydrogen. In another embodiment, the nonpassivated silicon is capable of reacting with water, at a pH of 7 and at room temperature (21° C.), to produce hydrogen.

It has been found that nonpassivated silicon produced by the process of the invention can be capable of reacting with water, at a pH of 7, and at a temperature of 90 ° C., to produce hydrogen, wherein the initial rate of hydrogen gas evolution is at least 0.10 cm³ min ⁻¹ g⁻¹. Typically, therefore, the nonpassivated silicon produced by the process of the invention, or used in the process of the invention for producing hydrogen, or employed in the compositions or pellets of the invention, is silicon which is capable of reacting with water, at a pH of 7, and at a temperature of 90° C., to produce hydrogen, wherein the initial rate of hydrogen gas evolution is at least 0.10 cm³ min⁻¹ g⁻¹ . In another embodiment, the nonpassivated silicon is silicon which is capable of reacting with water, at a pH of 7, and at a temperature of 90° C., to produce hydrogen, wherein the initial rate of hydrogen gas evolution is at least 0.15 cm³ min⁻¹ g⁻¹. In another embodiment, the nonpassivated silicon is silicon which is capable of reacting under these conditions wherein the initial rate of hydrogen gas evolution is at least 0.20 cm³ min⁻¹ g⁻¹ or, for instance, at least 0.25 cm³ min⁻¹ g⁻¹. In one embodiment, the nonpassivated silicon is silicon which is capable of reacting under these conditions wherein the initial rate of hydrogen gas evolution is at least 0.30 cm³ min⁻g⁻¹ or, for instance, at least 0.40 cm³ min⁻¹ g⁻¹ , or, in one embodiment, at least 0.50 cm³ min⁻¹ g⁻¹.

In another embodiment, the nonpassivated silicon produced by the process of the invention, or used in the process of the invention for producing hydrogen, or employed in the compositions or pellets of the invention, is silicon which is capable of reacting with water, at a pH of 7, and at a temperature of 90° C., to produce hydrogen, wherein the initial rate of hydrogen gas evolution is at least 0.50 cm³ min⁻¹g⁻¹, or preferably at least 0.60 cm³ min⁻¹ g⁻¹. More preferably, the nonpassivated silicon referred to herein is silicon capable of reacting with water, at a pH of 7, and at a temperature of 90° C., wherein the initial rate of hydrogen gas evolution is at least 0.60 cm³ min⁻¹ g⁻¹, or more preferably at least 0.70 cm³ min⁻¹ g⁻¹. Even more preferably, the nonpassivated silicon produces hydrogen under these conditions at an initial rate of at least 0.80 cm³ min⁻¹ g⁻¹. Such high initial rates of hydrogen evolution were achieved using samples prepared by wet milling.

The term “initial rate of hydrogen gas evolution” as used herein, refers to the rate of hydrogen gas evolution determined by recording the hydrogen evolution profile (i.e. the volume of hydrogen evolved as a function of time) and determining the gradient of the initial, substantially linear portion of the hydrogen evolution profile. Typically, this initial, substantially linear portion of hydrogen evolution occurs during the first 10 minutes of reaction, i.e. from 0 to 10 minutes after contacting the water with the nonpassivated silicon. Typically, therefore, the “initial rate of hydrogen gas evolution”, as used herein, refers to the rate of hydrogen gas evolution determined by measuring the gradient of the hydrogen evolution profile during the first 10 minutes of reaction.

It has been found that nonpassivated silicon produced by certain embodiments of the process of the invention is capable of reacting with water, at a pH of 7, and at a temperature of 90° C., to produce hydrogen, wherein the yield of hydrogen produced is at least 25%. The “yield of hydrogen”, as used herein and when expressed as a straight percentage (as opposed to weight %), refers to the overall volume of hydrogen produced by the process of the invention as a percentage of the theoretical volume of hydrogen produced if all the silicon is hydrolysed in accordance with the following reaction:

Si(s)+2H₂O (l)→SiO₂(s)+2H₂ (g)

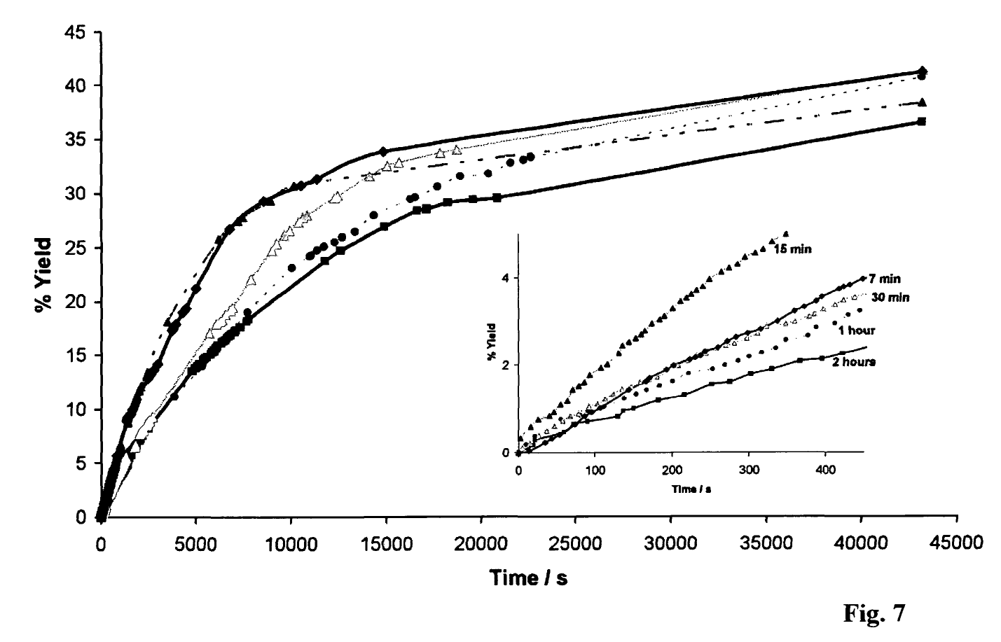

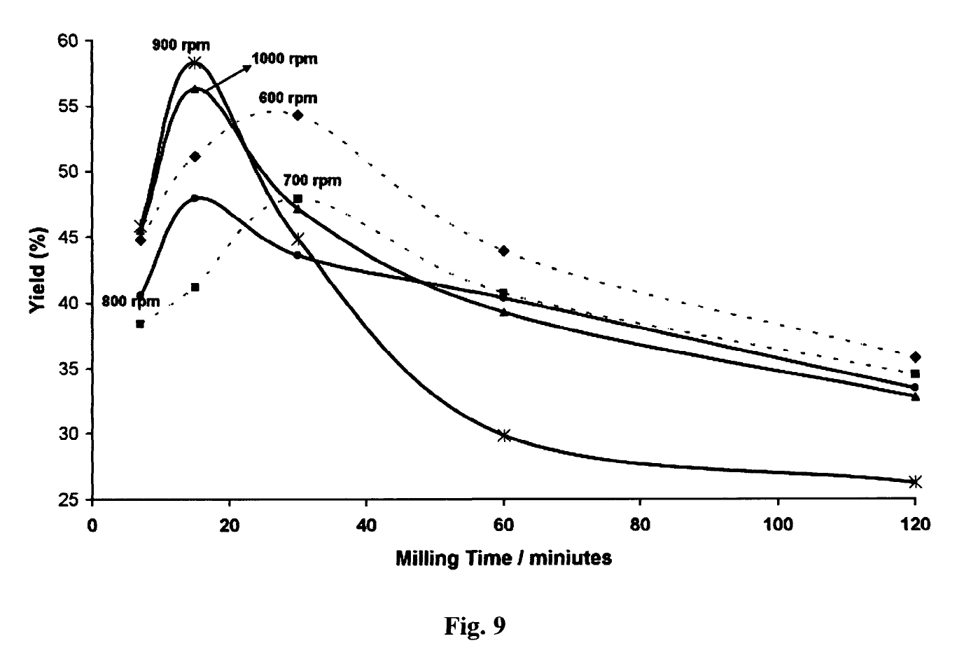

Typically, therefore, the nonpassivated silicon produced by the process of the invention, or used in the process of the invention for producing hydrogen, or employed in the compositions or pellets of the invention, is silicon which is capable of reacting with water, at a pH of 7, and at a temperature of 90° C., to produce hydrogen, wherein the yield of hydrogen produced is at least 25%. More typically, the nonpassivated silicon used herein is silicon capable of reacting with water, at a pH of 7, and at a temperature of 90° C., to produce hydrogen, wherein the yield of hydrogen produced is at least 30%, or, for instance, preferably at least 35%. In another preferred embodiment, the nonpassivated silicon used herein is silicon capable of reacting with water, at a pH of 7, and at a temperature of 90° C., to produce hydrogen, wherein the yield of hydrogen produced is at least 40%, or, for instance, more preferably at least 45%. In yet another embodiment, the nonpassivated silicon used herein is silicon capable of reacting with water, at a pH of 7, and at a temperature of 90° C., to produce hydrogen, wherein the yield of hydrogen produced is at least 50% or, even more preferably, at least 55%. Nonpassivated silicon capable of producing such high yields of hydrogen is obtainable by the process of the present invention as defined above for producing nonpassivated silicon (see for instance FIGS. 7, 9 and 11 herein).

It has furthermore been found that the nonpassivated silicon produced by certain embodiments of the process of the invention is capable of reacting with water, at a pH of 7, and at a temperature of 90° C., to produce hydrogen, wherein the yield of hydrogen produced is at least 5 weight % based on the mass of nonpassivated silicon used. The “yield of hydrogen”, as used herein and when expressed as a weight percentage (as opposed to a straight percentage), refers to the overall mass of hydrogen produced by the process of the invention as a percentage of the mass of nonpassivated silicon employed in the reaction.

Typically, therefore, the nonpassivated silicon produced by the process of the invention, or used in the process of the invention for producing hydrogen, or employed in the compositions or pellets of the invention, is silicon which is capable of reacting with water, at a pH of 7, and at a temperature of 90° C., to produce hydrogen, wherein the yield of hydrogen produced is at least 5 weight % based on the mass of nonpassivated silicon used. More typically, the nonpassivated silicon used herein is silicon capable of reacting with water, at a pH of 7, and at a temperature of 90° C., to produce hydrogen, wherein the yield of hydrogen produced is at least 6 weight % based on the mass of nonpassivated silicon used or, for instance, at least 7 weight % based on the mass of nonpassivated silicon used. In another preferred embodiment, the nonpassivated silicon used herein is silicon capable of reacting with water, at a pH of 7, and at a temperature of 90° C., to produce hydrogen, wherein the yield of hydrogen produced is at least 8 weight % based on the mass of nonpassivated silicon used. In yet another preferred embodiment, the nonpassivated silicon used herein is silicon capable of reacting with water, at a pH of 7, and at a temperature of 90° C., to produce hydrogen, wherein the yield of hydrogen produced is at least 9 weight % based on the mass of nonpassivated silicon used. Nonpassivated silicon capable of producing such high yields of hydrogen is obtainable by the process of the present invention as defined above for producing nonpassivated silicon (see the Examples herein).

It has furthermore been found that the nonpassivated silicon produced by certain embodiments of the process of the invention is capable of reacting with water, at a pH of 7, to produce hydrogen, wherein the activation energy of hydrolysis of said nonpassivated silicon, is less than or equal to 180 kJ mol⁻¹. The activation energy for the hydrolysis of nonpassivated silicon in accordance with the process of the invention, is determined from an Arrhenius plot of ln(initial rate of hydrogen gas evolution) vs 1/T.

Typically, therefore, the nonpassivated silicon produced by the process of the invention, or used in the process of the invention for producing hydrogen, or employed in the compositions or pellets of the invention, is silicon which is capable of reacting with water, at a pH of 7, to produce hydrogen, wherein the activation energy of hydrolysis of said nonpassivated silicon is less than or equal to 180 kJ mol⁻¹. Preferably, the nonpassivated silicon referred to herein is silicon which is capable of reacting with water, at a pH of 7, to produce hydrogen, wherein the activation energy of hydrolysis of said nonpassivated silicon is less than or equal to 140 kJ mol⁻¹. More preferably, the nonpassivated silicon referred to herein is silicon which is capable of reacting with water, at a pH of 7, to produce hydrogen, wherein the activation energy of hydrolysis of said nonpassivated silicon is less than or equal to 130 kJ mol⁻¹ or, even more preferably, less than or equal to 125 kJ mol⁻¹. In one embodiment, the nonpassivated silicon referred to herein is silicon which is capable of reacting with water, at a pH of 7, to produce hydrogen, wherein the activation energy of hydrolysis of said nonpassivated silicon is less than or equal to 100 kJ mol^{31 1}.

Typically, the nonpassivated silicon produced by the process of the invention, or used in the process of the invention for producing hydrogen, or employed in the compositions or pellets of the invention, is a silicon nanopowder. Thus, the nonpassivated silicon typically comprises, consists of, or consists essentially of nanoparticles of silicon. As used herein the term “nanoparticle” means a microscopic particle whose size is measured in nanometres (nm). Typically, a nanoparticle has a particle size of from 0.5 to 1000 nm, from 1 nm to 1000 nm, or for instance from 1 nm to 800 nm or from 1 nm to 600 nm. A nanoparticle may be crystalline or amorphous. The nonpassivated silicon nanoparticles referred to herein are typically crystalline. A nanoparticle may be spherical or non-spherical. Non-spherical nanoparticles may for instance be plate-shaped, needle-shaped or tubular. The term “particle size” as used herein means the diameter of the particle if the particle is spherical or, if the particle is non-spherical, the volume-based particle size. The volume-based particle size is the diameter of the sphere that has the same volume as the non-spherical particle in question.

Typically, the nonpassivated silicon produced by the process of the invention, or used in the process of the invention for producing hydrogen, or employed in the compositions or pellets of the invention, has a mean particle size of less than or equal to 500 nm. More typically, the nonpassivated silicon has a mean particle size of less than or equal to 400 nm, preferably less than or equal to 300 nm. In another embodiment, the nonpassivated silicon produced by the process of the invention, or used in the process of the invention for producing hydrogen, or employed in the compositions or pellets of the invention, has a mean particle size of less than or equal to 200 nm. In one embodiment, the mean particle size of the nonpassivated silicon is less than or equal to 100 nm, or, for instance, less than or equal to 80 nm. Typically, however, the mean particle size of the nonpassivated silicon is from 50 nm to 300 nm, more typically from 50 nm to 200 nm. In some embodiments, the mean particle size of the nonpassivated silicon is from 100 nm to 200 nm.

Typically, the particle size distribution of the particles of the nonpassivated silicon is such that 90% of the particles have a particle size of less than 800 nm. More typically, 90% of the particles have a particle size of less than 600 nm. Even more typically, 90% of the particles have a particle size of less than 500 nm or, for instance, less than 400 nm. In one embodiment, 90% of the particles have a particle size of less than 300 nm or, for instance, less than 250 nm.

In one embodiment, the nonpassivated silicon produced by the process of the invention, or used in the process of the invention for producing hydrogen, or employed in the compositions or pellets of the invention, has a mean particle size in the range of from 50 nm to 300 nm, wherein 90% of the particles have a particle size of less than 800 nm. In another embodiment, the nonpassivated silicon has a mean particle size in the range of from 50 nm to 200 nm, wherein 90% of the particles have a particle size of less than 800 nm. More typically, the nonpassivated silicon has a mean particle size in the range of from 50 nm to 200 nm, wherein 90% of the particles have a particle size of less than 500 nm, or, for instance, less than 400 nm, or less than 300 nm or less than 250 nm.

Usually, the ratio of Si to SiO₂ on the surface of the nonpassivated silicon, as measured by X-ray photoelectron spectroscopy, is at least 1:7. Preferably, however, the ratio of Si to SiO₂ on the nonpassivated silicon surface is greater than this, and is typically is at least 1:1, and is more preferably at least 2:1. In one embodiment, the ratio of Si to SiO₂ on the surface of the nonpassivated silicon, as measured by X-ray photoelectron spectroscopy, is at least 3:1. More preferably, the ratio of Si to SiO₂ on the nonpassivated silicon surface is at least 4:1, or, for instance, at least 5:1. In one preferred embodiment, the ratio of Si to SiO₂ on the surface of the nonpassivated silicon, as measured by X-ray photoelectron spectroscopy, is at least 6:1. Such silicon:silica ratios were observed for the nonpassivated silicon produced by milling as described in the Examples.

It was found that the nonpassivated silicon produced by the process of the invention may have an outer layer of silicon dioxide, on at least part of a surface thereof, which layer can have a thickness of up to 3.5 nm. Preferably, however, the thickness of such a layer, where present in the nonpassivated silicon, is less than or equal to 2 nm or, more preferably, less than or equal to 1 nm.

Typically, therefore, the nonpassivated silicon produced by the process of the invention, or used in the process of the invention for producing hydrogen, or employed in the compositions or pellets of the invention, has an outer layer of silicon dioxide, on at least part of a surface thereof, which layer has a thickness of equal to or less than 3.5 nm. More typically, the thickness of the layer is less than or equal to 2 nm or, more preferably, less than or equal to 1.0 nm. In one embodiment, the nonpassivated silicon has an outer layer of silicon dioxide, on at least part of a surface thereof, which layer has a thickness of less than 0.8 nm.

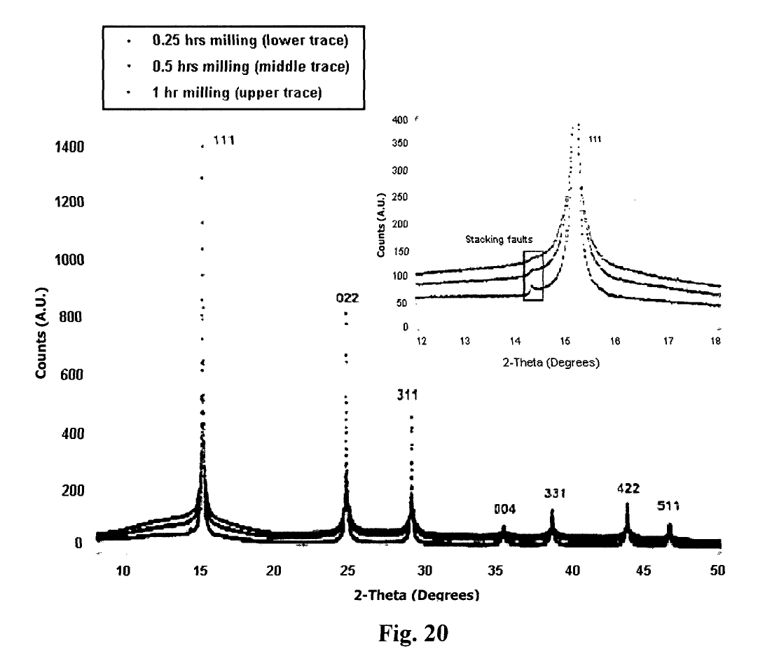

The nonpassivated silicon produced by the process of the invention typically comprises crystalline silicon. Usually, the crystalline silicon has a cubic lattice structure with space group Fd3m. The characteristic peaks for the 111, 022, 311, 004, 331, 422 and 511 planes of cubic (Fd3m) silicon are shown in FIG. 20.

Typically, therefore, the nonpassivated silicon produced by the process of the invention, or used in the process of the invention for producing hydrogen, or employed in the compositions or pellets of the invention, comprises cubic (Fd3m) silicon having characteristic X-ray diffraction peaks at two theta values of 15°, 25°, 29°, 36°, 38°, 44° and 47°, measured with a precision of ±0.5°, when a radiation wavelength of 0.83 angstroms is used.

Thus, typically, the nonpassivated silicon produced by the process of the invention, or used in the process of the invention for producing hydrogen, or employed in the compositions or pellets of the invention, comprises cubic (Fd3m) silicon having characteristic X-ray diffraction peaks at two theta values of 15°±0.5°, 25°±0.5°, 29°±0.5°, 36°±0.5°, 38°±0.5°, 44°±0.5° and 47°±0.5° when a radiation wavelength of 0.83 angstroms is used.

The crystalline nonpassivated silicon produced by the process of the invention is thought to contain a certain amount of crystallographic disorder. Evidence suggests that the degree of this disorder increased with increased milling time. This is explained further in Example 3 hereinbelow, and in accompanying FIG. 20. Specifically, a general increase in the width of the Bragg peaks for cubic Si was observed with increased milling time, and this is consistent with a decrease in particle size coupled with the creation of crystallographic disorder. An additional peak, not associated with the structure of cubic (Fd-3m) silicon, was observed at about 14.5° 2-theta (between about 14.0° and about) 14.8°. This peak was of an unusual shape commonly associated with the presence of stacking defects within the structure. This feature remained visible even with the significant increase in background intensity observed with increased milling time, which suggests that the feature at about 14.5° 2-theta increases in intensity with milling time. This in turn corresponds to an increase in stacking fault density with prolonged milling.

The experimental evidence therefore suggests that the process of the invention for producing nonpassivated silicon creates significant stacking fault defects within the silicon structure. This increased crystallographic disorder produced by the process serves to increase the reactivity of the resulting nonpassivated silicon, and increase the yield of hydrogen that can be produced on reaction with water. The defects in the structure represent additional nonpassivated surfaces with which water can react, and which enable the build-up of a thicker layer of silicon oxide by-product than would otherwise be possible. The defects therefore increase reactivity and enable higher yields of hydrogen to be produced.

Typically, therefore, the nonpassivated silicon produced by the process of the invention, or used in the process of the invention for producing hydrogen, or employed in the compositions or pellets of the invention, comprises cubic (Fd3m) silicon, wherein the cubic (Fd3m) silicon comprises crystallographic disorder. Typically, the crystallographic disorder is characterised by an X-ray diffraction peak at a two theta value of from 14.0° to 14.8°, when a radiation wavelength of 0.83 angstroms is used. More typically, the crystallographic disorder is characterised by an X-ray diffraction peak at a two theta value of about 14.5°. Thus, the crystallographic disorder is typically characterised by an X-ray diffraction peak at a two theta value of 14.5°±0.5°.

The crystallographic disorder usually comprises stacking fault defects. Thus, the nonpassivated silicon produced by the process of the invention, or used in the process of the invention for producing hydrogen, or employed in the compositions or pellets of the invention, may comprise cubic (Fd3m) silicon which comprises stacking fault defects. Typically, the stacking fault defects are characterised by an X-ray diffraction peak at a two theta value of from 14.0° to 14.8°, when a radiation wavelength of 0.83 angstroms is used. More typically, the stacking fault defects are characterised by an X-ray diffraction peak at a two theta value of about 14.5°. Thus, the stacking fault defects are typically characterised by an X-ray diffraction peak at a two theta value of 14.5°±0.5°.

In one embodiment, the nonpassivated silicon produced by the process of the invention, or used in the process of the invention for producing hydrogen, or employed in the compositions or pellets of the invention, comprises crystalline silicon having characteristic X-ray diffraction peaks at two theta values of 15°, 25°, 29°, 36°, 38°, 44° and 47°, measured with a precision of ±0.5°, and an additional peak at a two theta value of from 14.0° to 14.8°, when a radiation wavelength of 0.83 angstroms is used. More typically, the additional peak has a two theta value of about 14.5°. The additional peak may have a two theta value of 14.5°±0.5°. The additional peak typically has a low intensity compared to said characteristic X-ray diffraction peaks.

Thus, the nonpassivated silicon produced by the process of the invention, or used in the process of the invention for producing hydrogen, or employed in the compositions or pellets of the invention, typically comprises crystalline silicon having characteristic X-ray diffraction peaks at two theta values of 15°±0.5°, 25°±0.5°, 29°±0.5°, 36°±0.5°, 38°±0.5°, 44°±0.5° and 47°±0.5° and an additional peak at a two theta value of from 14.0° to 14.8°, when a radiation wavelength of 0.83 angstroms is used. More typically, the additional peak has a two theta value of about 14.5°. The additional peak may have a two theta value of 14.5°±0.5°. The additional peak typically has a low intensity compared to said characteristic X-ray diffraction peaks.

In one embodiment, the nonpassivated silicon produced by the process of the invention, or used in the process of the invention for producing hydrogen, or employed in the compositions or pellets of the invention, comprises crystalline silicon having an X-ray diffraction pattern substantially as shown in FIG. 20. This includes the low intensity feature at the two theta value between 14.0° and 14.8° (i.e. at about)14.5° representing crystallographic disorder. The phrase “an X-ray diffraction pattern substantially as shown in FIG. 20”, as used herein, means an X-ray diffraction pattern which is substantially the same as any one of the three diffraction patterns shown in FIG. 20. “Substantially the same” means that the X-ray diffraction pattern has peaks at the same two theta values as any of the three diffraction patterns shown in FIG. 20, including (a) the characteristic peaks for the 111, 022, 311, 004, 331, 422 and 511 planes of cubic (Fd3m) silicon and (b) the feature of relatively low intensity at a two theta of from 14.0° to 14.8° (i.e. at about) 14.5° representing crystallographic disorder, and no additional peaks in the two theta range shown in FIG. 20.

Thus, while the term “nonpassivated silicon” as used herein, refers to silicon that is capable of reacting with water, at a pH of from 5.5 to 8.5, and at a temperature which is equal to or less than 100° C., to produce hydrogen, the nonpassivated silicon produced by the process of the invention, or used in the process of the invention for producing hydrogen, or employed in the compositions or pellets of the invention may have any one or more of the aforementioned additional features.

Typically, in the process of the invention as defined above for producing hydrogen, which comprises contacting water with nonpassivated silicon (and thereby producing hydrogen by hydrolysis of the silicon), the water has a pH of less than or equal to 9. Thus, the water may form part of an acidic or a slightly alkaline solution. It is to be understood therefore that the water employed in the process of the invention for producing hydrogen need not be pure. The water may for instance contain salts, minerals or organic impurities, and it may be acidic or even slightly alkaline.

In terms of pH, however, the water used in the process of the present invention for producing hydrogen usually has a pH of less than 8.5. More typically, the water has a pH of less than 8.0. The pH is typically also not less than 4, and is more typically at least 5.5.

Typically, therefore, the water used in the process of the present invention has a pH of from 5.5 to 8.5. More typically, the water has a pH of from 6.0 to 8.0. The water is most typically pH neutral, i.e. about pH 7. In one embodiment, the pH of the water is 7.0.

Usually, the process of the invention as defined above for producing hydrogen is carried out at an elevated temperature. Advantageously, however, relatively low temperatures (e.g. temperatures of less than or equal to 100° C.) can be used to generate fairly high yields of hydrogen. Typically, therefore, the hydrolysis reaction is carried out at a temperature of from 20° C. to 100° C. More typically, the hydrolysis reaction is carried out at a temperature of from 30° C. to 100° C., or, for instance, from 40° C. to 100° C. Preferably, the reation temperature employed is from 60° C. to 100° C., for instance from 70° C. to 95° C.

Typically, therefore, the process further comprises heating the water to a temperature of up to 100° C. More typically, the process comprises heating the water to a temperature of from 30° C. to 100° C., or, for instance, from 40° C. to 100° C. Preferably, the water is heated to a temperature of from 60° C. to 100° C. or, for instance from 70° C. to 95° C. In one embodiment, the process further comprises heating the water to a temperature of from 60° C. to 90° C.

Usually, the water is heated to said temperature prior to the step of contacting the water with the nonpassivated silicon. Furthermore, the water is usually then maintained at said temperature for the duration of the hydrolysis reaction. As is evident from the Examples, the hydrolysis reaction can reach completion (or at least near-completion) within about 2 to 12 hours depending on the reactivity of the nonpassivated silicon. The duration of the hydrolysis reaction may therefore be up to 12 hours. The water may therefore be maintained at said temperature for up to 12 hours. The duration of the hydrolysis reaction is preferably however less than 12 hours. Typically, therefore, the duration of the hydrolysis reaction is less than about 6 hours, for instance 5 hours or less, or, say, 4 hours or less. In one embodiment the duration of the hydrolysis reaction is less than about 3 hours, for instance less than about 2 hours.

The reaction mixture is typically agitated, e.g. by stirring, during the hydrolysis reaction.

Typically, the process of the invention as defined above for producing hydrogen further comprises recovering said hydrogen. The gas can be recovered from the reaction mixure as it evolves, by conventional methods. The hydrogen gas may then be stored, for later use, or alternatively may be used straight away.

Typically, the initial rate of hydrogen gas evolution in the process of the invention for producing hydrogen is at least 0.05 cm³ min⁻¹ g⁻¹. Preferably, however, the initial rate of hydrogen gas evolution is at least 0.15 cm³ min⁻¹ g⁻¹, at least 0.20 cm³ min⁻¹ g⁻¹ or, for instance, at least 0.25 cm³ min⁻¹ g⁻¹. In another embodiment, the initial rate of hydrogen gas evolution is at least 0.30 cm³ min⁻¹ g⁻¹, and is preferably at least 0.40 cm³ min⁻¹ g¹, more preferably at least 0.50 cm³ min⁻¹ g⁻¹.

Usually, the yield of hydrogen in the process of the invention for producing hydrogen is at least 25%, based on the theoretical volume of hydrogen produced if all the silicon is hydrolysed. Preferably, however, the yield of hydrogen is at least 30%, or, for instance, at least 35%. In another preferred embodiment, the yield of hydrogen in the process of the invention is at least 40%, more preferably at least 45%. In yet another embodiment, the yield of hydrogen produced is at least 50% or, even more preferably, at least 55%.

The activation energy for said hydrolysis of the nonpassivated silicon is typically less than or equal to 180 kJ mol⁻¹, preferably less than or equal to 140 kJ mol⁻¹, more preferably less than or equal to 130 kJ mol⁻¹ or, even more preferably, less than or equal to 125 kJ mol⁻¹, or, for instance, less than or equal to 100 kJ mol⁻¹.

Typically, in the process of the invention for producing hydrogen as defined above at least 5 weight % hydrogen is produced based on the weight of the nonpassivated silicon employed. Preferably, however, at least 6 weight % hydrogen, or, for instance, at least 7 weight % hydrogen, based on the mass of nonpassivated silicon used, is generated. In another preferred embodiment, the yield of hydrogen produced is at least 8 weight % based on the mass of nonpassivated silicon used. In yet another preferred embodiment, at least 9 weight % hydrogen is produced based on the weight of said nonpassivated silicon.

The nonpassivated silicon employed in the process of the invention for producing hydrogen is of course silicon that is capable of reacting with water, at a pH of from 5.5 to 8.5, and at a temperature which is equal to or less than 100° C., to produce hydrogen. The nonpassivated silicon employed may however be as further defined hereinbefore.

In one embodiment, the nonpassivated silicon is provided in the form of one or more encapsulates, wherein the one or more encapsulates comprise said nonpassivated silicon encapsulated within an organic coating. The purpose of such a coating is to prevent or reduce exposure of the nonpassivated silicon to air prior to use, and thereby prevent passivation of the silicon. The coating typically therefore provides a good seal from the atmosphere, in order to prevent or reduce exposure of the nonpassivated silicon to air; any suitable coating material that prevents the ingress of air and which can be removed on contact with water can be used. The coating typically dissolves, degrades or melts away when the pellet is added to water. In one embodiment, therefore, the organic coating is a water-soluble coating. In another embodiment, the organic coating has a low melting point, e.g. a melting point of from 30° C. to 100° C., more typically from 50° C. to 100° C., or from 50° C. to 90° C.

Typically, the organic coating is capable of dissolving, degrading or melting away upon exposure to water having a temperature less than or equal to 100° C. and a pH of from 5 to 9. More typically, the organic coating is capable of dissolving, degrading or melting away upon exposure to water having a temperature less than or equal to 100° C. and a pH of 7. Even more typically, the organic coating is capable of dissolving, degrading or melting away upon exposure to water having a temperature less than or equal to 90° C. and a pH of 7.

In one embodiment, the organic coating is gelatine. Typically, therefore, the organic coating comprises gelatine. In one embodiment, the organic coating comprises agar. Other suitable organic coating materials may include greases, and natural and synthetic polymers and plastics. Polyvinyl alcohol, for instance, is a suitable polymer that could be used, by virtue of its solubility in water.

When the nonpassivated silicon is provided in the form of one or more encapsulates, the process typically comprises contacting said water with the one or more encapsulates and allowing the organic coating to dissolve, degrade or melt away, thereby contacting the water with the nonpassivated silicon.

When the nonpassivated silicon is provided in the form of one or more encapsulates, in one embodiment the organic coating is a water-soluble coating and the process comprises contacting said water with the one or more encapsulates and allowing the water-soluble coating to dissolve, thereby contacting the water with the nonpassivated silicon.

The nonpassivated silicon used in the process of the invention for producing hydrogen may be as further defined herein in relation to the composition of the invention which comprises nonpassivated silicon.

The nonpassivated silicon used in the process of the invention for producing hydrogen may be nonpassivated silicon which is obtainable by the process of the invention as defined herein for producing nonpassivated silicon.

Similarly the process of the invention for producing hydrogen may further comprise a step of producing the nonpassivated silicon by the process of the invention as defined herein for producing nonpassivated silicon.

In another embodiment, however, the nonpassivated silicon used in the process of the invention for producing hydrogen comprises nanoparticles of silicon produced using other techniques. Silicon nanoparticles could for instance be synthesised by plasma synthesis or by wet chemical synthesis methods. The production of nanoparticles by plasma synthesis is described by D. Vollath in “Plasma Synthesis of Nanoparticles” KONA No.25 (2007) pp. 39-55. Rosso-Vasic et al., J. Mater. Chem., 2009, 19, 5926-5933, on the other hand, indicates that free-standing Si nanoparticles can be produced using a variety of techniques, such as: ultrasonic dispersion of electrochemically etched silicon; laser-driven pyrolysis of silane; synthesis in supercritical fluids; and wet chemistry techniques, including reduction of Zintl salts in inert organic solvents and in micelles using SiX₄ (X═Cl, Br or I) as a silicon source. Rosso-Vasic et al. also describe the production of silicon nanoparticles by the reduction of Si(OCH₃)₄ within micelles in dry toluene, using LiAlH₄ as a reducing agent.

In one embodiment, therefore, the nonpassivated silicon used in the process of the invention for producing hydrogen comprises nanoparticles of silicon.

Such nanoparticles of silicon may be obtainable by reducing a silicon salt in the presence of an organic solvent; by reducing a silicon salt contained within micelles; by plasma synthesis; by ultrasonic dispersion of electrochemically etched silicon; by laser-driven pyrolysis of silane; or by synthesis in supercritical fluids.

In one embodiment, the nonpassivated silicon used in the process of the invention for producing hydrogen comprises nanoparticles of silicon and the process further comprises producing the nanoparticles of silicon by reducing a silicon salt in the presence of an organic solvent; by reducing a silicon salt contained within micelles; by plasma synthesis; by ultrasonic dispersion of electrochemically etched silicon; by laser-driven pyrolysis of silane; or by synthesis in supercritical fluids.

Alternatively, the nonpassivated silicon may be prepared by laser ablation, for instance by providing a sample of silicon and, under inert conditions, reducing the amount of surface silicon oxide by laser ablation.

The process of the invention for producing nonpassivated silicon comprises providing a sample of silicon and, under inert conditions, reducing the mean particle size in the sample by applying a mechanical force thereto.

The term “inert conditions” as used herein refers to a substantially dry (moisture-free), oxygen-free, non-oxidising environment in which the nonpassivated silicon can be produced and preserved without significant re-passivation. Such an environment can be provided by a dry, oxygen-free, inert gas (e.g. nitrogen or argon), by a vacuum, or for instance by performing the process in a dry, de-aerated aprotic solvent (an inert solvent). The inert solvent is aprotic and therefore other than an alcohol.

Accordingly, the step of reducing the mean particle size in the sample is typically performed in an inert gas (i.e. under an inert atmosphere). Usually, in this embodiment, the step of reducing the mean particle size is performed under nitrogen or argon.

In another embodiment, the step of reducing the mean particle size in the sample is performed in an inert solvent (as, for instance, in the “wet” milling process described in Example 2). In this embodiment, the step may be performed either in the presence of an inert gas (in addition to the inert solvent) or in the absence of an inert gas. Thus, in one embodiment, the inert solvent is itself under an inert gas atmosphere, for instance under nitrogen or argon. In an alternative embodiment, the inert conditions necessary for producing and preserving nonpassivated silicon are provided simply by performing the step of reducing the mean particle size in an inert solvent.

Performing the step of reducing the mean particle size by applying a mechanical force in the presence of a solvent was found to produce nonpassivated silicon which exhibits significantly enhanced rates of hydrolysis and improved hydrogen yields compared to nonpassivated silicon prepared in the absence of solvent. The adsorption of solvent onto the newly formed silicon surfaces lowers the surface energy and accelerates the process, hence the time required to produce high surface area particles is considerably reduced. Furthermore the adsorbtion of solvent suppresses the oxidation of silicon particles that would otherwise inhibit the hydrolysis. Suitable solvents include dry (moisture free) solvents that do not contain any OH groups, and dry, aprotic, organic solvents.

Typically, therefore, in the process of the invention for producing nonpassivated silicon, the step of reducing the mean particle size of the sample is performed in a dry (moisture free) solvent that does not contain any OH groups. The solvent is therefore other than an alcohol.

Usually, the step of reducing the mean particle size of the sample is performed in a dry, aprotic, solvent, which is typically an organic solvent.

Suitable solvents include, for instance, acetonitrile, dimethylsulfoxide, an aromatic or aliphatic C₁₋₂₀ hydrocarbon (e.g. toluene, benzene, petroleum ether), a C₁₋₂₀ halocarbon (e.g. dichloromethane, chlorobutane, chloroform, carbon tetrachloride), a C₁₋₂₀ paraffin, or a C₁₋₂₀ straight-chained or cyclic ether (e.g. tetrahydrofuran, diethyl ether).

In one embodiment, the solvent used is acetonitrile.

The mechanical force applied to the sample in order to reduce the particle size may comprise attribution (friction), impact or cutting, or a combination of such forces. Such forces are involved in milling. Milling may be defined as the mechanical reduction of the particle size of a sample by attribution (friction), impact or cutting (IUPAC Compendium of Chemical Terminology, 2nd ed., the “Gold Book”, compiled by A. D. McNaught and A. Wilkinson, Blackwell Scientific Publications, Oxford, 1997). Ball milling, for instance primarily involves the mechanical reduction of the particle size of a sample by both attribution (friction) and impact. Typically, therefore, the mechanical force applied to the sample in order to reduce the particle size comprises attribution (friction) and impact.

Accordingly, in one embodiment of the process of the invention for producing nonpassivated silicon, the step of reducing the mean particle size in the sample comprises reducing the particle size by attribution (friction), impact and/or cutting. Typically, the step of reducing the mean particle size in the sample comprises reducing the particle size by attribution (friction) and impact.

Typically, the step of reducing the mean particle size in the sample comprises milling, grinding or crushing the sample. More typically, the step of reducing the mean particle size in the sample comprises milling the sample.

Typically, the sample of silicon has a first mean particle size and the step of reducing the mean particle size in the sample causes the mean particle size to be reduced from said first mean particle size to a second mean particle size, wherein the second mean particle size is less than the first mean particle size. Typically, the second particle size is less than or equal to 500 nm, preferably less than or equal to 400 nm, more preferably less than or equal to 300 nm. In another embodiment, the second mean particle size is less than or equal to 200 nm. In one embodiment, the second mean particle size is less than or equal to 100 nm, or, for instance, less than or equal to 80 nm. In another embodiment, the second mean particle size is less than or equal to 50 nm. Usually, however, the second mean particle size is from 50 nm to 300 nm, more typically from 50 nm to 200 nm. In some embodiments, the second mean particle size is from 100 nm to 200 nm.

The first mean particle size is typically greater than 500 nm, for instance greater than 1000 nm, or greater than 10 μm. The first mean particle size is typically in the order of micrometres (μm) or millimetres (mm), given that coarse, granular silicon pieces may be used for the initial sample of silicon. Accordingly, said first mean particle size may for instance be from 1 μm to 1 cm, or for instance from 100 μm to 1 cm.

Typically, said silicon in said sample bears an outer layer of silicon dioxide on at least part of a surface thereof, wherein said outer layer of silicon dioxide has a first thickness, and wherein the step of reducing the mean particle size in the sample causes the average thickness of said outer layer of silicon dioxide to decrease from said first thickness to a second thickness, the second thickness being less than the first thickness. Typically, the second thickness is less than or equal to 3.5 nm. More typically, the second thickness is less than or equal to 2 nm or, more preferably, less than or equal to 1.0 nm. In one embodiment, the second thickness is less than 0.8 nm. In another embodiment, the second thickness is less than 0.5 nm, more typically less than or equal to 0.4 nm, or for instance less than or equal to 0.3 nm. The first thickness is typically greater than 0.8 nm, more typically greater than 1.0 nm, even more typically greater than 2 nm and even more typically greater than 3.5 nm. The first thickness may for instance be in the range of from 0.8 nm to 10 nm, or from 1.0 to 10 nm, or for instance from 3.5 nm to 20 nm.

Typically, the step of reducing the mean particle size in the sample causes the ratio of Si to SiO₂ on the surface of said sample, as measured by X-ray photoelectron spectroscopy, to increase from a first ratio to a second ratio, wherein the second ratio is greater than the first ratio. Typically, the second ratio is at least 1:1, more typically at least 2:1, and preferably at least 3:1. More preferably, the second ratio is at least 4:1, or, for instance, at least 5:1. In one preferred embodiment, the second ratio is at least 6:1. Typically, the first ratio of Si to SiO₂ is less than 1:7. More typically, the first ratio is less than 1:10.

Typically, the step of reducing the mean particle size in the sample causes the reactivity of the sample, with pH-neutral water at 90° C. to produce hydrogen, to increase from a first initial rate of hydrogen gas evolution to a second initial rate of hydrogen gas evolution, wherein the second rate is greater than the first rate. The second rate is typically at least 0.05 cm³ min⁻¹ g⁻¹, more typically at least 0.10 cm³ min⁻¹ g⁻¹ , and preferably at least 0.25 cm³ min⁻¹ g⁻¹ . In one embodiment, however, the second rate is at least 0.30 cm³ min⁻¹ g⁻¹ or, for instance, at least 0.40 cm³ min⁻¹ g⁻¹, or, in one embodiment, at least 0.50 cm³ min⁻¹ g⁻¹. In yet another embodiment, the second rate is at least 0.60 cm³ min⁻¹ g⁻¹ or, for instance, at least 0.70 cm³ min⁻¹ g⁻¹, or, in one embodiment, at least 0.80 cm³ min⁻¹ g⁻¹. Typically, the first initial rate is 0 cm³ min⁻¹ g⁻¹, due to the fact that coarse, granular Si particles are generally employed as the initial sample of silicon, which are highly efficiently passivated with SiO₂ layers. Such passivated silicon does not react with pH-neutral water.

Typically, the step of reducing the mean particle size in the sample of silicon causes the yield of hydrogen produced, when reacting said silicon with pH-neutral water at 90° C., to increase from a first yield to a second yield, wherein the second yield is greater than the first yield. Typically, the second yield is at least 25%, preferably at least 30%, or, for instance, at least 35%. In a preferred embodiment, the second yield is at least 40%, or, for instance, more preferably at least 45%. In yet another embodiment, the second yield is at least 50% or, more preferably, at least 55%. Typically, the first yield is 0%, due to the fact that coarse, granular Si particles are generally employed as the initial sample of silicon, which are passivated highly efficiently with SiO₂ layers. Such passivated silicon does not react with pH-neutral water.

Typically, the step of reducing the mean particle size in the sample of silicon causes the yield of hydrogen produced, when reacting said silicon with pH-neutral water at 90° C., to increase from a first amount to a second amount. Typically, the second amount is greater than the first amount, and wherein the second amount is at least 5 weight % hydrogen based on the weight of said silicon, preferably at least 6 weight % hydrogen based on the weight of said silicon, more preferably at least 7 weight % hydrogen based on the weight of said silicon, even more preferably at least 8 weight % hydrogen based on the weight of said silicon. In a particularly preferred embodiment, the second amount is at least 9 weight % hydrogen based on the weight of said silicon. Typically, the first amount is 0 weight %, due to the fact that coarse, granular Si particles are generally employed as the initial sample of silicon, which are passivated highly efficiently with SiO₂ layers.

Typically, the silicon in said sample has a first activation energy of hydrolysis of silicon, using pH-neutral water, to produce hydrogen, and wherein the step of reducing the mean particle size in the sample causes said first activation energy to decrease to a second activation energy, wherein the second activation energy is less than the first activation energy. The second activation energy may be less than or equal to 180 kJ mol⁻¹. Typically, the second activation energy is less than or equal to 150 kJ mol⁻¹. More typically, the second activation energy is less than or equal to 140 kJ mol⁻¹, or, for instance, less than or equal to 130 kJ mol⁻¹ or, even more preferably, less than or equal to 125 kJ mol⁻¹. In one embodiment, the second activation energy is less than or equal to 100 kJ mol⁻¹. The first activation energy is typically greater than 180 kJ mol⁻¹.

Typically, the silicon in said sample (i.e. the silicon starting material) comprises crystalline silicon.

Usually, said silicon in said sample comprises cubic (Fd-3m) crystalline silicon having characteristic X-ray diffraction peaks at two theta values of 15°, 25°, 29°, 36°, 38°, 44° and 47°, measured with a precision of ±0.5°, when a radiation wavelength of 0.83 angstroms is used.

Thus, usually, the silicon in said sample (i.e. the silicon starting material) comprises cubic (Fd-3m) crystalline silicon having characteristic X-ray diffraction peaks at two theta values of 15°±0.5°, 25°±0.5°, 29°±0.5°, 36°±0.5°, 38°±0.5°, 44°±0.5°and 47°±0.5° when a radiation wavelength of 0.83 angstroms is used.

The step of reducing the mean particle size in the sample usually causes the crystallographic disorder in said crystalline silicon to increase.

Typically, the step of reducing the mean particle size in the sample causes crystallographic disorder characterised by an X-ray diffraction peak at a two theta value between 14.0° and 14.8°, when a radiation wavelength of 0.83 angstroms is used. More typically, the crystallographic disorder is characterised by an X-ray diffraction peak at a two theta value of about 14.5°, when a radiation wavelength of 0.83 angstroms is used. Thus, the crystallographic disorder is usually characterised by an X-ray diffraction peak at a two theta value of 14.5°±0.5°, when a radiation wavelength of 0.83 angstroms is used.

The crystallographic disorder typically comprises stacking fault defects. Accordingly, the step of reducing the mean particle size in the sample typically increases the number of stacking fault defects in said crystalline silicon.

Typically, the step of reducing the mean particle size in the sample causes stacking fault defects characterised by an X-ray diffraction peak at a two theta value between 14.0° and 14.8°, when a radiation wavelength of 0.83 angstroms is used. More typically, the stacking fault defects are characterised by an X-ray diffraction peak at a two theta value of about 14.5°, when a radiation wavelength of 0.83 angstroms is used. Thus, the stacking fault defects may be characterised by an X-ray diffraction peak at a two theta value of 14.5°±0.5°, when a radiation wavelength of 0.83 angstroms is used.

Thus, in one embodiment, said silicon in said sample comprises cubic (Fd-3m) crystalline silicon having characteristic X-ray diffraction peaks at two theta values of 15°, 25°, 29°, 36°, 38°, 44° and 47°, measured to a precision of ±0.5°, when a radiation wavelength of 0.83 angstroms is used, and the step of reducing the mean particle size in the sample causes the crystallographic disorder in said crystalline silicon to increase, wherein the resulting nonpassivated silicon has said characteristic X-ray diffraction peaks at two theta values of 15°, 25°, 38°, 44° and 47°, measured to a precision of ±0.5°, and an additional peak at a two theta value of from 14.0° to 14.8°, when a radiation wavelength of 0.83 angstroms is used. The additional peak typically has a low intensity compared to said characteristic X-ray diffraction peaks. The additional peak may have a two theta value of about 14.5°, for instance a two theta value of 14.5°±0.5°. Typically, the resulting nonpassivated silicon has an X-ray diffraction pattern substantially as shown in FIG. 20.

Thus, said silicon in said sample may comprise cubic (Fd-3m) crystalline silicon having characteristic X-ray diffraction peaks at two theta values of 15°±0.5°, 25°±0.5°, 29°±0.5°, 36°±0.5°, 38°±0.5°, 44°±0.5° and 47°±0.5° when a radiation wavelength of 0.83 angstroms is used, and the step of reducing the mean particle size in the sample causes the crystallographic disorder in said crystalline silicon to increase, wherein the resulting nonpassivated silicon has said characteristic X-ray diffraction peaks at two theta values of 15°±0.5°, 25°±0.5°, 29°±0.5°, 36°±0.5°, 38°±0.5°, 44°±0.5° and 47°±0.5° and an additional peak at a two theta value of from 14.0° to 14.8°, when a radiation wavelength of 0.83 angstroms is used. The additional peak typically has a low intensity compared to said characteristic X-ray diffraction peaks. The additional peak may have a two theta value of about 14.5°, for instance a two theta value of 14.5°±0.5°. Typically, the resulting nonpassivated silicon has an X-ray diffraction pattern substantially as shown in FIG. 20.

In one embodiment of the process of the invention for producing nonpassivated silicon, the step of reducing the mean particle size of the sample comprises milling the sample. Any suitable milling technique can be employed, although ball milling is usually employed.

Typically, therefore, the step of reducing the mean particle size of the sample comprises milling the sample using a ball mill. Ball milling per se is well known. A ball mill typically comprises a rotating a milling chamber, typically a cylinder, which is partially filled with grinding balls, usually stone or metal, which grind material to the necessary fineness by friction and impact with the tumbling balls. The feed is typically at one end of the cylinder and the discharge at the other. Ball mills are commonly used in the manufacture of cement. These industrial ball mills are mainly large machines, although small versions of ball mills can be found in laboratories. The process of the invention is therefore amenable to scale-up to an industrial scale.

Typically, therefore, the process of the invention for producing nonpassivated silicon comprises:

(a) providing said sample of silicon and a plurality of grinding balls in a milling chamber of a ball mill;

(b) introducing an inert atmosphere and/or an inert solvent into said milling chamber; and

(c) milling said sample using said ball mill.

Steps (a) and (b) may be performed in any order or at the same time, i.e. (a) first then (b), (b) first then (a), or (a) and (b) together.

As is explained in the Examples hereinbelow, the choice of milling speed and duration can affect the nature of the nonpassivated silicon produced. For instance, the choice of milling speed and duration can affect the reactivity of the resulting nonpassivated silicon with water, the yield of hydrogen produced by that reaction, the activation energy of hydrolysis of the nonpassivated silicon, the mean particle size of the nonpassivated silicon, the ratio of Si to SiO₂ on the surface of the nonpassivated silicon, and the thickness of an outer layer of silicon dioxide on the nonpassivated silicon.

Typically, therefore the speed and duration of milling are selected to cause the mean particle size to be reduced from a first mean particle size to a second mean particle size, wherein the second mean particle size is less than the first mean particle size. The first and second particle sizes may be as defined hereinbefore. Typically, therefore, the second particle size is less than or equal to 300 nm, preferably less than or equal to 200 nm. In another embodiment, the second particle size is less than or equal to 50 nm.

Similarly, the speed and duration of milling may be selected to cause the average thickness of an outer layer of silicon dioxide on the silicon sample to decrease from a first thickness to a second thickness, wherein the second thickness is less than the first thickness. The first and second particle sizes may be as defined hereinbefore. Typically, therefore, the second thickness is less than or equal to 3.5 nm, preferably less than or equal to 1.0 nm or, for instance, less than or equal to 0.8 nm. In another embodiment, the second thickness is less than 0.5 nm, more typically less than or equal to 0.4 nm, or for instance less than or equal to 0.3 nm.

Similarly, the speed and duration of milling may be selected to cause the ratio of Si to SiO₂ on the surface of said sample, as measured by X-ray photoelectron spectroscopy, to increase from a first ratio to a second ratio, wherein the second ratio is greater than the first ratio. The first and second ratios may be as defined hereinbefore. Typically, therefore, the second ratio is at least 2:1, preferably at least 3:1.

Similarly, the speed and duration of milling may be selected to cause the reactivity of the sample, with pH-neutral water at 90° C. to produce hydrogen, to increase from a first initial rate of hydrogen gas evolution to a second initial rate of hydrogen gas evolution, wherein the second rate is greater than the first rate. The first and second rates may be as defined hereinbefore. Typically, therefore, the second rate is at least 0.10 cm³ min⁻¹ g⁻¹ , preferably at least 0.30 cm³ min⁻¹ g⁻¹.

Similarly, the speed and duration of milling may be selected to cause the yield of hydrogen produced, when reacting said silicon with pH-neutral water at 90° C., to increase from a first yield to a second yield, wherein the second yield is greater than the first yield. The first and second yields may be as defined hereinbefore. Typically, therefore, the second yield is at least 25%, preferably at least 50%.

Similarly, the speed and duration of milling may be selected to cause the yield of hydrogen produced, when reacting said silicon with pH-neutral water at 90° C., to increase from a first amount to a second amount, wherein the second amount is greater than the first amount. The first and second yields may be as defined hereinbefore, expressed as weight % hydrogen based on the weight of said silicon. Typically, therefore, the second amount is at least 5 weight % hydrogen based on the weight of said silicon, more preferably at least 9 weight % hydrogen based on the weight of said silicon.

Similarly, the speed and duration of milling may be selected to cause a first activation energy of hydrolysis of silicon, using pH-neutral water, to produce hydrogen, to decrease to a second activation energy, wherein the second activation energy is less than the first activation energy. The first and second activation energies may be as defined hereinbefore. Typically, therefore, the second activation energy is less than or equal to 180 kJ mol⁻¹.

Similarly, when the silicon in said sample (i.e. the silicon starting material) comprises crystalline silicon, the speed and duration of milling may be selected to cause the crystallographic disorder in said crystalline silicon to increase. In particular, the speed and duration of milling may be selected to cause the number of stacking fault defects in said crystalline silicon to increase.

Typically, said silicon in said sample comprises cubic (Fd-3m) crystalline silicon having characteristic X-ray diffraction peaks at two theta values of 15°, 25°, 29°, 36°, 38°, 44° and 47°, measured with a precision of ±0.5°, when a radiation wavelength of 0.83 angstroms is used, and the speed and duration of milling is selected to cause the crystallographic disorder in said crystalline silicon to increase, wherein the resulting nonpassivated silicon has said characteristic X-ray diffraction peaks at two theta values of 15°, 25°, 29°, 36°, 38°, 44° and 47°, measured with a precision of ±0.5°, and an additional peak at a two theta value of from 14.0° to 14.8° (typically about)14.5°, when a radiation wavelength of 0.83 angstroms is used. Typically, the resulting nonpassivated silicon has an X-ray diffraction pattern substantially as shown in FIG. 20. The additional peak may have a two theta value of 14.5°±0.5°.

Typically, said silicon in said sample comprises cubic (Fd-3m) crystalline silicon having characteristic X-ray diffraction peaks at two theta values of 15°±0.5°, 25°±0.5°, 29°±0.5°, 36°±0.5°, 38°±0.5°, 44°±0.5° and 47°±0.5° when a radiation wavelength of 0.83 angstroms is used, and the speed and duration of milling is selected to cause the crystallographic disorder in said crystalline silicon to increase, wherein the resulting nonpassivated silicon has said characteristic X-ray diffraction peaks at two theta values of 15°±0.5°, 25°±0.5°, 29°±0.5°, 36°±0.5°, 38°±0.5°, 44°±0.5° and 47°±0.5° and an additional peak at a two theta value of from 14.0° to 14.8° (typically about)14.5°, when a radiation wavelength of 0.83 angstroms is used. Typically, the resulting nonpassivated silicon has an X-ray diffraction pattern substantially as shown in FIG. 20. The additional peak may have a two theta value of 14.5°±0.5°.

Milling speeds in excess of 500 rpm are typically employed, for instance speeds of at least 600 rpm. Milling speeds of from 500 rpm to 1200 rpm may for instance be employed. More typically, milling speeds of from 600 to 1000 rpm are employed. The highest initial reaction rates were typically observed in the range 700 rpm to 1000 rpm, and particularly in the range 750 rpm to 950 rpm.

Accordingly, in the process of the invention for producing nonpassivated silicon, the milling speed is typically from 600 rpm to 1000 rpm, preferably from 650 rpm to 950 rpm, more preferably from 700 rpm to 950 rpm, even more preferably from 750 rpm to 950 rpm.

The sample may be milled for any suitable duration. Typically, however the sample is milled for a duration of less than or equal to 3 hours. The sample may for instance be milled for a duration of from 2 minutes to 3 hours, or more typically from 5 minutes to 2 hours.

Typically, when the sample is milled in the absence of solvent, shorter milling times are preferred in order to minimise surface oxidation during the milling process. Thus, when the sample is milled in the absence of solvent, it is typically milled for a duration of from 5 minutes to 80 minutes, preferably for a duration of from 5 minutes to 40 minutes, and more preferably for a duration of from 5 minutes to 20 minutes.

In one embodiment, the sample is milled in an inert atmosphere, preferably under nitrogen or argon gas, for a duration of from 5 minutes to 80 minutes, preferably for a duration of from 5 minutes to 40 minutes, more preferably for a duration of from 5 minutes to 20 minutes.

When the sample is milled in the presence of an inert solvent (“wet milling”), the milling is more efficient and surface oxidation of silicon is minimised. Thus, when the sample is milled in an inert solvent, a wider range of milling times may be employed. Typically, therefore, when the sample is milled in an inert solvent, the sample is milled for a duration of from 2 minutes to 3 hours. More typically, when the sample is milled in an inert solvent, the sample is milled for a duration of from 2 minutes to 2 hours or, for instance, from 2 minutes to 1 hour. Even more typically, when the sample is milled in an inert solvent, the sample is milled for a duration of from 2 minutes to 40 minutes, preferably for a duration of from 4 minutes to 30 minutes, more preferably for a duration of from 5 minutes to 15 minutes.

Silicon starting materials having a wide rage of purities can be used in the process of the invention for producing nonpassivated silicon. For instance, the sample of silicon provided (i.e. the silicon starting material) may be metallurgical grade silicon. Metallurgical grade silicon is commercially available and is passivated by a layer of surface SiO₂. It is produced industrially by reduction of silica using carbon in a submerged arc electric furnace. The silicon produced in the liquid state is then cast in ingots. After solidification and cooling, the ingots may be crushed and then ground into a powder. The composition of metallurgical grade silicon is typically as follows: Si≧98 wt %, Fe≦0.40 wt %, Ca≦0.20 wt %, Al≦0.20 wt %, and further impurities include oxygen, nitrogen and carbon. Lower grades of silicon, with lower silicon contents, may also be used as the starting material in the process of the invention. For instance, starting materials with a silicon content as low as 90 weight % may be used. Such materials include silicon with a high content of oxygen (e.g. in the form of SiO₂ or silicates). Other such materials include Si-based alloys, in particular those used in the manufacture of silicones, which may contain one of the elements Fe, Al, Ca or Cu in quantities of up to 8%. Preferably, however, the sample of silicon does not contain any alloy of silicon and a metal. Other, higher grades of commercially available silicon can also of course be used, for instance silicons are available containing up to 99.95% Si (but are still of course passivated by a layer of surface SiO₂).

Typically, therefore in the process of the invention for producing nonpassivated silicon, the sample of silicon provided (i.e. the silicon starting material) contains at least 90 weight % Si. For instance, the sample of silicon provided may contain from 90 to 95 wt % Si. Or, for instance, the sample of silicon provided may contain from 90 to 97 wt % Si, or for instance from 90 to 98 wt % Si, or from 90 to 99 wt % Si.

More typically, the sample of silicon provided contains at least 95 weight % Si. Thus, the sample of silicon provided may contain from 95 to 97 wt % Si, from 95 to 98 wt % Si, or for instance from 95 to 99 wt % Si.

The sample of silicon provided may be metallurgical grade silicon. Thus, in one embodiment, the sample of silicon provided contains at least 97 weight % Si. Usually, the sample of silicon provided contains at least 98 weight % Si. The sample of silicon provided may for instance contain from 97.0 to 99.0 wt % Si, or for instance from 97.0 to 99.5 wt % Si. In another embodiment, the sample of silicon provided contains from 97.0 to 99.9 weight % Si.

More typically, the sample of silicon provided contains from 98.0 to 99.0 wt % Si, or for instance from 98.0 to 99.5 wt % Si. In another embodiment, the sample of silicon provided contains from 98.0 to 99.9 weight % Si.

In another embodiment, the sample of silicon provided contains at least 99 weight % Si, for instance at least 99.5 weight % Si. In another embodiment, the sample of silicon provided contains at least 99.9 weight % Si.

Typically, in the process of the invention for producing nonpassivated silicon, the sample of silicon provided (i.e. the silicon starting material) comprises granular silicon or coarse silicon particles. Such silicon is commercially available and is passivated by a layer of surface SiO₂. The sample of silicon typically therefore consists essentially of elemental silicon, i.e. it contains elemental silicon, and the surface layer of SiO₂; it may also contain other materials, such as for instance impurities, provided that the essential characteristics of the sample of silicon (most importantly its ability to be converted into nonpassivated silicon by the process of the present invention) are not materially affected by their presence. As well as oxygen, such impurities may include carbon, nitrogen, and trace amounts of metals such as Fe, Al and Ca. The mean particle size of the sample of silicon (i.e. the silicon starting material) is typically in the order of micrometres (μm), millimetres (mm) or even centimetres. The sample of silicon typically does not contain any alloy of silicon and a metal. For instance, in one embodiment the sample of silicon does not comprise any alloy of silicon and aluminium.

The nonpassivated silicon produced by the process of the invention also typically consists essentially of elemental silicon. It may therefore contain other materials, such as for instance impurities, or a small amount of surface oxide, provided that the essential characteristic of being able to react with water, at a pH of from 5.5 to 8.5, and at a temperature which is equal to or less than 100° C., to produce hydrogen, is not materially affected by their presence. The nonpassivated silicon typically does not contain any alloy of silicon and aluminium. More typically, the sample of silicon does not comprise any alloy of silicon and a metal.

Typically, the process of the invention for producing nonpassivated silicon further comprises a step of: recovering said nonpassivated silicon. Typically, the step of recovering said nonpassivated silicon is carried out under inert conditions, in order to prevent re-passivation of the silicon (for instance by exposure to air or moisure). Typically, the step of recovering said nonpassivated silicon is carried out in an inert atmosphere such as under nitrogen or argon.

When a milling apparatus, for instance a ball mill, is employed, the step of recovering said nonpassivated silicon comprises recovering the nonpassivated silicon from the milling apparatus.

When the step of reducing the mean particle size of the sample is carried out in the presence of an inert solvent, as defined above, the step of recovering said nonpassivated silicon typically comprises a solvent removal step. Typically, the solvent removal step is performed under inert conditions, typically under an inert gas such as nitrogen or argon. The solvent is typically removed in vacuo (i.e. under reduced pressure).

In another embodiment, the process further comprises preserving the nonpassivated silicon under inert conditions. The nonpassivated silicon is then kept ready for subsequent use, without passivation. Typically the nonpassivated silicon is preserved under an inert gas such as nitrogen or argon.

In one embodiment, the process of the invention further comprises coating the nonpassivated silicon with an organic coating, to form one or more encapsulates which comprise nonpassivated silicon within an organic coating. Typically, the organic coating is suitable for preventing or reducing the ingress of air and therefore for preserving the silicon in its nonpassivated form. Yet the coating dissolves, degrades or melts away when the pellet is added to water, thereby exposing the nonpassivated silicon to water such that it can react with the water to produce hydrogen. The coating may for instance have a low melting point such that it melts away when brought into contact with warm or hot water or, for instance, the coating may dissolve in water or degrade when brought into contact with water. In one embodiment, the organic coating is a water-soluble coating. Any suitable coating material that prevents the ingress of air when not in contact with water, and which can dissolve, degrade or melts away when brought into contact with water can be used.

Typically, the organic coating is capable of dissolving, degrading or melting away upon exposure to water having a temperature less than or equal to 100° C. and a pH of from 5 to 9. More typically, the organic coating is capable of dissolving, degrading or melting away upon exposure to water having a temperature less than or equal to 100° C. and a pH of 7. Even more typically, the organic coating is capable of dissolving, degrading or melting away upon exposure to water having a temperature less than or equal to 90° C. and a pH of 7. The organic coating may for instance be a water-soluble coating. Additionally or alternatively, the organic coating may have a low melting point, e.g. a melting point of from 30° C. to 100° C., more typically from 50° C. to 100° C., or from 50° C. to 90° C.

One such suitable material is gelatine. Typically, therefore, the organic coating comprises gelatine. In one embodiment, the organic coating comprises agar. Other suitable materials may include natural and synthetic polymers and plastics, for instance polyvinyl alcohol (which is a water soluble polymer) and greases.

The invention further provides a composition which comprises nonpassivated silicon. Said nonpassivated silicon is by definition capable of reacting with water, at a pH of from 5.5 to 8.5, and at a temperature which is equal to or less than 100° C., to produce hydrogen. However, the nonpassivated silicon of the invention may be as further defined herein.

For instance, the nonpassivated silicon is typically capable of reacting with water, at a pH of 7, and at a temperature of 90° C., to produce hydrogen, wherein the initial rate of hydrogen gas evolution is at least 0.05 cm³ min⁻¹ g⁻¹. Preferably, however, the initial rate of hydrogen gas evolution is at least 0.15 cm³ min⁻¹ g⁻¹, at least 0.20 cm³ min⁻¹ g⁻¹ or, for instance, at least 0.25 cm³ min⁻¹ g⁻¹. In another embodiment, the initial rate of hydrogen gas evolution is at least 0.30 cm³ min⁻¹ g⁻¹, and is preferably at least 0.40 cm³ min⁻¹ g⁻¹, more preferably at least 0.50 cm³ min⁻¹ g⁻¹.

Furthermore, the nonpassivated silicon is typically capable of reacting with water, at a pH of 7, and at a temperature of 90° C., to produce hydrogen, wherein the yield of hydrogen produced is at least 25% based on the theoretical volume of hydrogen produced if all the silicon is hydrolysed. Preferably, however, the yield of hydrogen is at least 30%, or, for instance, at least 35%. In another preferred embodiment, the yield of hydrogen is at least 40%, more preferably at least 45%. In yet another embodiment, the yield of hydrogen produced is at least 50% or, even more preferably, at least 55%.

Typically, the nonpassivated silicon is capable of reacting with water, at a pH of 7, and at a temperature of 90° C., to produce at least 5 weight % hydrogen based on the mass of said nonpassivated silicon. In a preferred embodiment, the nonpassivated silicon is capable of reacting with water, at a pH of 7, and at a temperature of 90° C., to produce at least 6 weight % hydrogen, or, for instance, at least 7 weight % hydrogen, based on the mass of nonpassivated silicon used. In another preferred embodiment, the yield of hydrogen produced is at least 8 weight % based on the mass of nonpassivated silicon used. In yet another preferred embodiment, at least 9 weight % hydrogen is produced based on the weight of said nonpassivated silicon.

Typically, in the composition of the invention the activation energy of hydrolysis of said nonpassivated silicon, using pH-neutral water, is less than or equal to 180 kJ mol⁻¹, less than or equal to 140 kJ mol⁻¹, more preferably less than or equal to 130 kJ mol⁻¹ or, even more preferably, less than or equal to 125 kJ mol⁻¹. In one embodiment, it is less than or equal to 100 kJ mol⁻¹.

Typically, the nonpassivated silicon is a “silicon nanopowder”, having a mean particle size of less than or equal to 500 nm, or for instance less than or equal to 300 nm. The mean particle size may be as further defined hereinbefore. Similarly, the particle size distribution of the nonpassivated silicon may be as further defined hereinbefore. In one embodiment, the nonpassivated silicon has a mean particle size in the range of from 50 nm to 200 nm, wherein 90% of the particles have a particle size of less than 500 nm.

In one embodiment of the composition of the invention, the ratio of Si atoms to SiO₂ moieties on the surface of said nonpassivated silicon, as measured by X-ray photoelectron spectroscopy, is at least 2:1. However, this ratio may be as further defined hereinbefore.

The nonpassivated silicon may bear an outer layer of silicon dioxide, on at least part of a surface thereof, which layer has an average thickness of less than or equal to 3.5 nm. More typically, the layer has an average thickness of less than or equal to 1.0 nm, or, preferably less than or equal to 0.8 nm.

The nonpassivated silicon typically comprises crystalline silicon. It may consist essentially of crystalline silicon. In another embodiment, the nonpassivated silicon consists of crystalline silicon.

The crystalline silicon in these embodiments may be as further defined herein. In particular, it may be cubic (Fd3m) silicon, wherein the cubic (Fd3m) silicon comprises crystallographic disorder.

Typically, the crystallographic disorder is characterised by an X-ray diffraction peak at a two theta value between 14.0° and 14.8°, when a radiation wavelength of 0.83 angstroms is used. More typically, the crystallographic disorder is characterised by an X-ray diffraction peak at a two theta value of about 14.5°, when a radiation wavelength of 0.83 angstroms is used. Thus, the crystallographic disorder may be characterised by an X-ray diffraction peak having a two theta value of 14.5°±0.5°, when a radiation wavelength of 0.83 angstroms is used.

The crystallographic disorder usually comprises stacking fault defects. Typically, the stacking fault defects are characterised by an X-ray diffraction peak at a two theta value between 14.0° and 14.8°, when a radiation wavelength of 0.83 angstroms is used. More typically, the stacking fault defects are characterised by an X-ray diffraction peak at a two theta value of about 14.5°, when a radiation wavelength of 0.83 angstroms is used. Thus, the stacking fault defects may be characterised by an X-ray diffraction peak having a two theta value of 14.5°±0.5°, when a radiation wavelength of 0.83 angstroms is used.

In one embodiment, the nonpassivated silicon comprises crystalline silicon having characteristic X-ray diffraction peaks at two theta values of 15°, 25°, 29°, 36°, 38°, 44° and 47°, measured with a precision of ±0.5°, and an additional peak at a two theta value of from 14.0° to 14.8° (typically about)14.5°, when a radiation wavelength of 0.83 angstroms is used. In other embodiments, the nonpassivated silicon consists of, or consists essentially of, crystalline silicon having characteristic X-ray diffraction peaks at two theta values of 15°, 25°, 29°, 36°, 38°, 44° and 47°, measured with a precision of ±0.5°, and an additional peak at a two theta value of from 14.0° to 14.8° (typically about)14.5°, when a radiation wavelength of 0.83 angstroms is used.

Thus, the nonpassivated silicon may comprise crystalline silicon having characteristic X-ray diffraction peaks at two theta values of 15°±0.5°, 25°±0.5°, 29°±0.5°, 36°±0.5°, 38°±0.5°, 44°±0.5° and 47°±0.5° and an additional peak at a two theta value of from 14.0° to 14.8° (typically about)14.5°, when a radiation wavelength of 0.83 angstroms is used. In other embodiments, the nonpassivated silicon consists of, or consists essentially of, crystalline silicon having characteristic X-ray diffraction peaks at two theta values of 15°±0.5°, 25°±0.5°, 29°±0.5°, 36°±0.5°, 38°±0.5°, 44°±0.5° and 47°±0.5° and an additional peak at a two theta value of from 14.0° to 14.8° (typically about)14.5°, when a radiation wavelength of 0.83 angstroms is used.

The additional peak usually has a two theta value of about 14.5°±0.5°, or more typically, 14.5°±0.3°, when a radiation wavelength of 0.83 angstroms is used. The additional peak is typically of a lower intensity than said characteristic X-ray diffraction peaks.

In one embodiment, the nonpassivated silicon comprises (or consists of, or consists essentially of) crystalline silicon having an X-ray diffraction pattern substantially as shown in FIG. 20, including the feature between 14.0° and 14.8° (at about14.5°).

Said feature usually has a two theta value of about 14.5°±0.5°, or more typically, 14.5°±0.3°, when a radiation wavelength of 0.83 angstroms is used.

The composition of the invention may comprise one or more encapsulates, wherein the one or more encapsulates comprise said nonpassivated silicon encapsulated within an organic coating. The organic coating is typically suitable for preventing or reducing exposure of the nonpassivated silicon to air. Typically, the organic coating is capable of dissolving, degrading or melting away upon exposure to water having a temperature less than or equal to 100° C. and a pH of from 5 to 9. More typically, the organic coating is capable of dissolving, degrading or melting away upon exposure to water having a temperature less than or equal to 100° C. and a pH of 7. Even more typically, the organic coating is capable of dissolving, degrading or melting away upon exposure to water having a temperature less than or equal to 90° C. and a pH of 7. The organic coating may for instance be a water-soluble coating. Additionally or alternatively, the organic coating may have a low melting point, e.g. a melting point of from 30° C. to 100° C., more typically from 50° C. to 100° C., or from 50° C. to 90° C. The organic coating may be as further defined hereinbefore; it typically comprises gelatine.

The invention further provides nonpassivated silicon which is obtainable by the process of the invention for producing nonpassivated silicon as defined herein.

The invention further provides the use of nonpassivated silicon to produce hydrogen, by hydrolysis of the nonpassivated silicon. The nonpassivated silicon, in this embodiment, may be as further defined hereinbefore.

The invention further provides a pellet for generating hydrogen, the pellet comprising nonpassivated silicon encapsulated within an organic coating. Such pellets may be used as a convenient means for the local generation of hydrogen. For instance for local generation of hydrogen fuel, e.g. to power a fuel cell. The nonpassivated silicon, in this embodiment, may be as further defined hereinbefore. The organic coating, in this embodiment, is suitable for preventing or reducing exposure of the nonpassivated silicon to air, and may be as further defined hereinbefore. Typically, the organic coating is capable of dissolving, degrading or melting away upon exposure to water having a temperature less than or equal to 100° C. and a pH of from 5 to 9. More typically, the organic coating is capable of dissolving, degrading or melting away upon exposure to water having a temperature less than or equal to 100° C. and a pH of 7. Even more typically, the organic coating incapable of dissolving, degrading or melting away upon exposure to water having a temperature less than or equal to 90° C. and a pH of 7. The organic coating may for instance be a water-soluble coating. Additionally or alternatively, the organic coating may have a low melting point, e.g. a melting point of from 30° C. to 100° C., more typically from 50° C. to 100° C., or from 50° C. to 90° C. The coating typically comprises gelatine.

By applying the processes of the invention for producing nonpassivated silicon and for generating hydrogen, an overall model can be conceived wherein Si is produced with renewable energy to form an “energy carrier”, and reacted locally at point of application with a “hydrogen carrier”, water, to produce hydrogen with the simple disposal of quartz sand as the only by-product. An initial step of this model could involve the green conversion of silica to silicon, and then to nonpassivated silicon, which can then release hydrogen on demand simply upon addition of water. Silica which is regenerated as a by-product of the hydrolysis can either be safely disposed of or recycled.

The invention is further illustrated in the Examples which follow:

### EXAMPLES

### Example 1

### Preparation of Nonpassivated Silicon by Dry Milling, and its Reaction With Water to Generate Hydrogen Gas

This Example describes the preparation of mechanically milled Si, which readily generates hydrogen when contacted with water, even well below 100° C. Hydrogen yields calculated on a hydrogen:silicon weight ratio of 5.13 wt %-9.11wt %, corresponding to specific energies of 7.34 and 13.06 MJ kg⁻¹ respectively, were observed for the Si powders prepared, which were characterised by a range of physical methods. The Example shows that the reaction of Si with pure water, generating SiO₂ as the only by-product, is a viable route for the local supply of hydrogen.

Milling Experiments

Silicon pieces (99.95%, 2.5 g, 88.9 mmol) were placed in a tempered steel vial containing 5 mm diameter steel balls (41.6 g) corresponding to a silicon: ball ratio of 1:17. The vials were purged with nitrogen (99.9%) using a FRITSCH gassing lid for 30 minutes prior to milling. Samples were milled for periods of 7 min, 15 min, 30 min, 1 hour and 2 hours at speeds ranging from 600-1000 rpm in 100 rpm increments using a Pulverisette 7 premium line mechanical mill. After milling the samples were manipulated and stored in a nitrogen glove box, purged with 99.9% nitrogen.

Hydrolysis Experiments

The hydrolysis reactions were carried out in a 100 cm³ glass reactor with three openings, one for the addition of the milled silicon powder to the heated water, one for monitoring the temperature and the other one for use as a hydrogen exhaust. The reactor containing water (60 cm³, 3.3 mol) was heated with a water bath to the chosen temperature, normally in the range 60-90° C. The silicon powder (0.6 g, 21.4 mmol) was packed into a gelatine capsule (100%, Agar) which was dropped into the reactor flask. A magnetic stirrer agitated the solution throughout the course of the reaction. The hydrogen produced by the hydrolysis of the milled silicon was passed through a water bath at ambient temperature via a Tygon tube of length 40 cm and internal diameter of 3 mm in order to condense any water vapour and was collected in an inverted burette. Gas chromatography confirmed that the evolved gas was indeed hydrogen,

Physical Characterisation

Powder X-ray Diffraction (XRD) patterns were recorded on a Panalytical instrument using monochromated Cu K_{α1} radiation (λ=1.5046 Å). Scanning electron microscopy (SEM) was carried out on a field emission JEOL 840F instrument at an accelerating voltage of 8 KV. Energy dispersive X-ray analysis (EDX) was performed on an Oxford instruments 840A system at an accelerating voltage of 20 kV using Inca Energy analytical software. X-ray photoelectron spectroscopy (XPS) measurements were carried out on a Scienta ESCA 300. A flood gun was used to control charging and the binding energies were referenced to surface elemental carbon at 284.6 eV. XPS data was fitted using the CasaXPS program. Oxide film thicknesses (d) were calculated from

$$\frac{{I}^{{SiO}_{2}}}{{I}^{si}} = \frac{{D}^{{SiO}_{2}} ( 1 - {e}^{- d / λ cos θ} )}{{D}^{Si} {e}^{- d / λ cos θ}}$$

where D denotes the Si atom density in the phase, λ is the Si 2p electron mean free path taken as 1.8 nm, and θ is the emission angle which was averaged to 45° in these calculations.

Results and Discussion

Granular silicon pieces were placed in a steel mechanical mill fitted with tempered steel balls, which were subsequently flushed through with nitrogen, after which the sample was milled for a predetermined time, at a particular speed. The samples were then transferred under nitrogen to a sealed storage bottle, in preparation for characterisation and reaction studies. Energy dispersive X-ray (EDX) analysis revealed the presence of only silicon and oxygen in the milled silicon powders with no iron contaminants from the grinding media being detected. The X-ray diffraction patterns of all samples were characteristic of crystalline silicon, confirming that significant amorphisation was not taking place. However peak broadening could be seen, which primarily increased with milling time. For example, use of the Debye-Scherrer equation yielded particle sizes of 33 run, after 7 minutes milling at 800 rpm, dropping to 10 nm after 2 hours milling. Such calculations are likely to underestimate the particle size, since they ignore contributions to line broadening from increasing crystallographic disorder, which are believed to be significant.

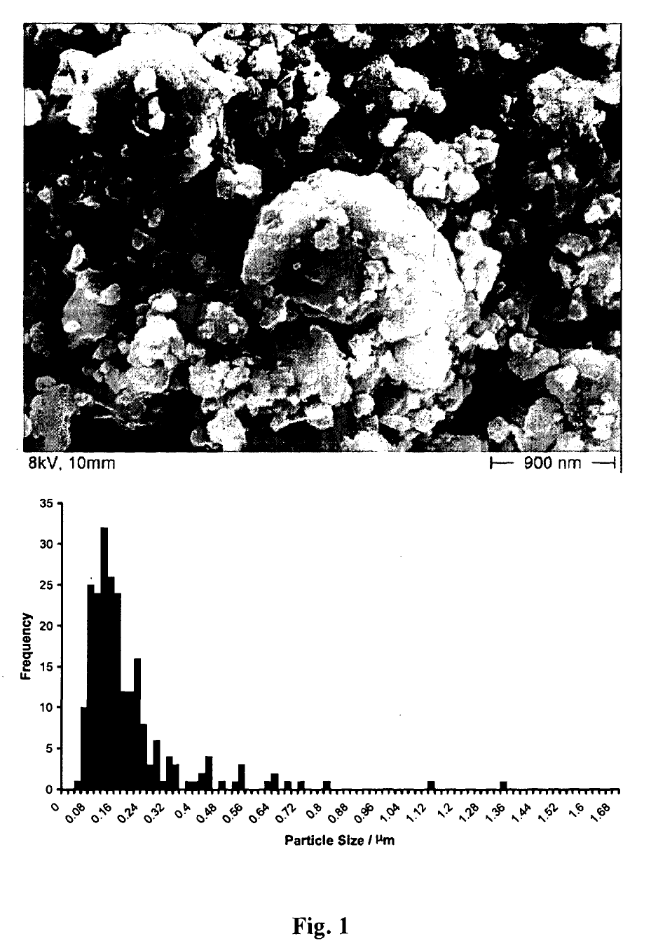

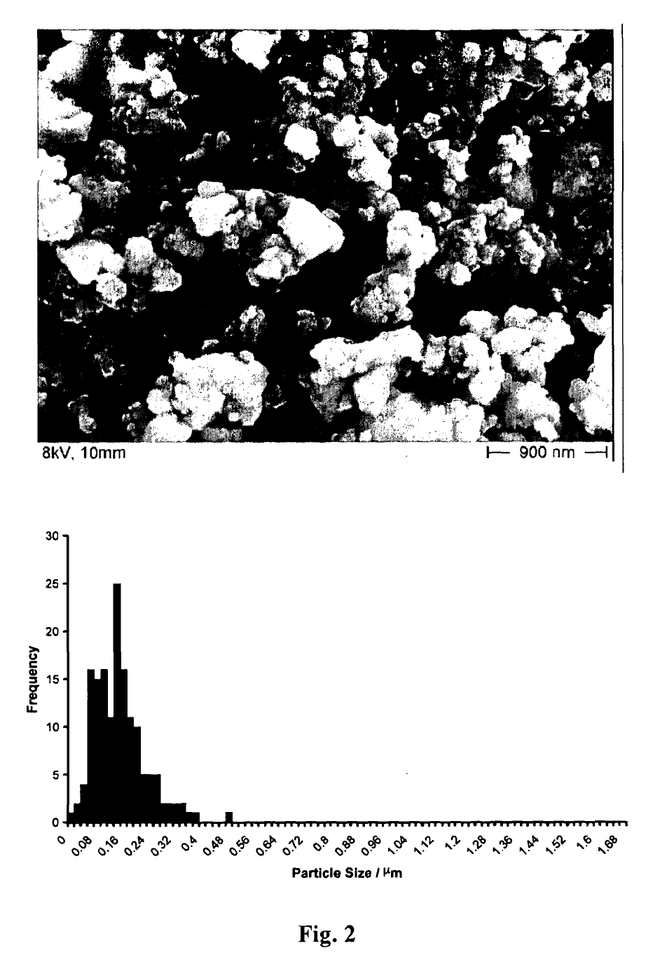

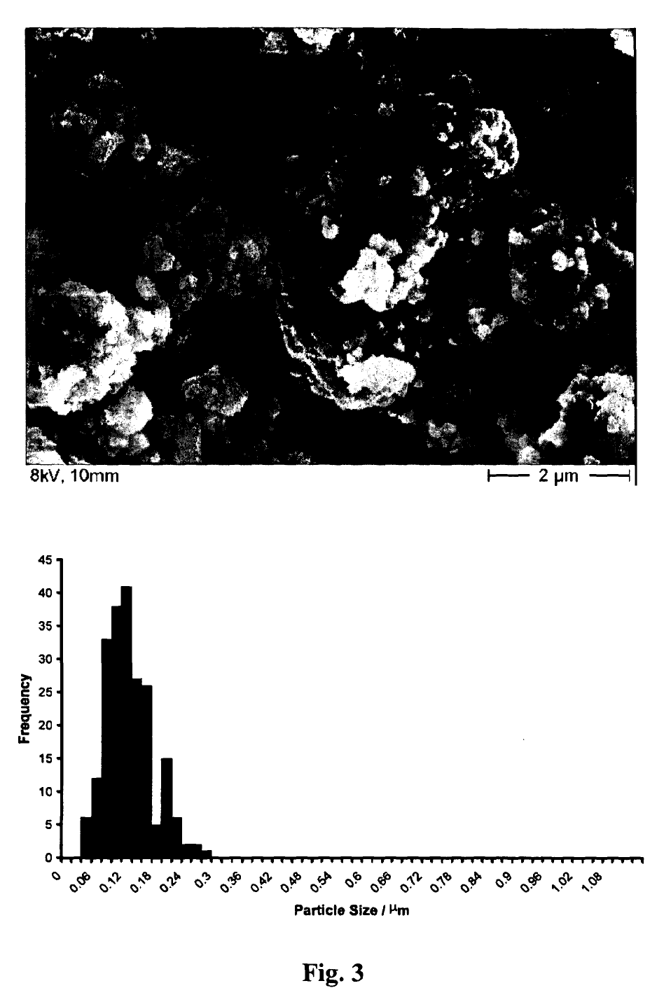

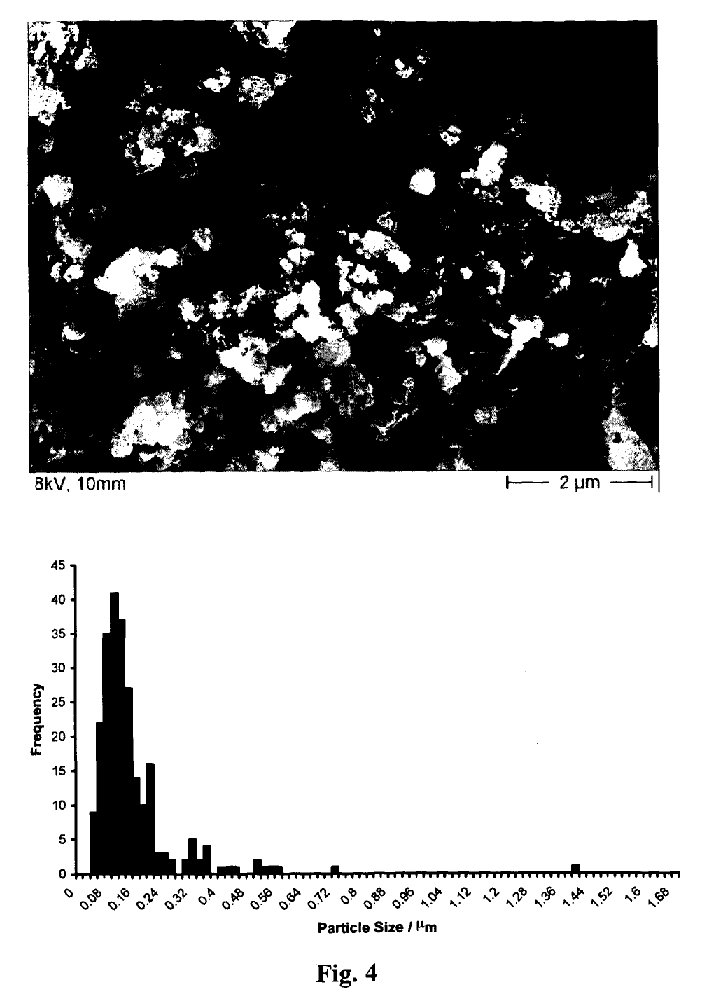

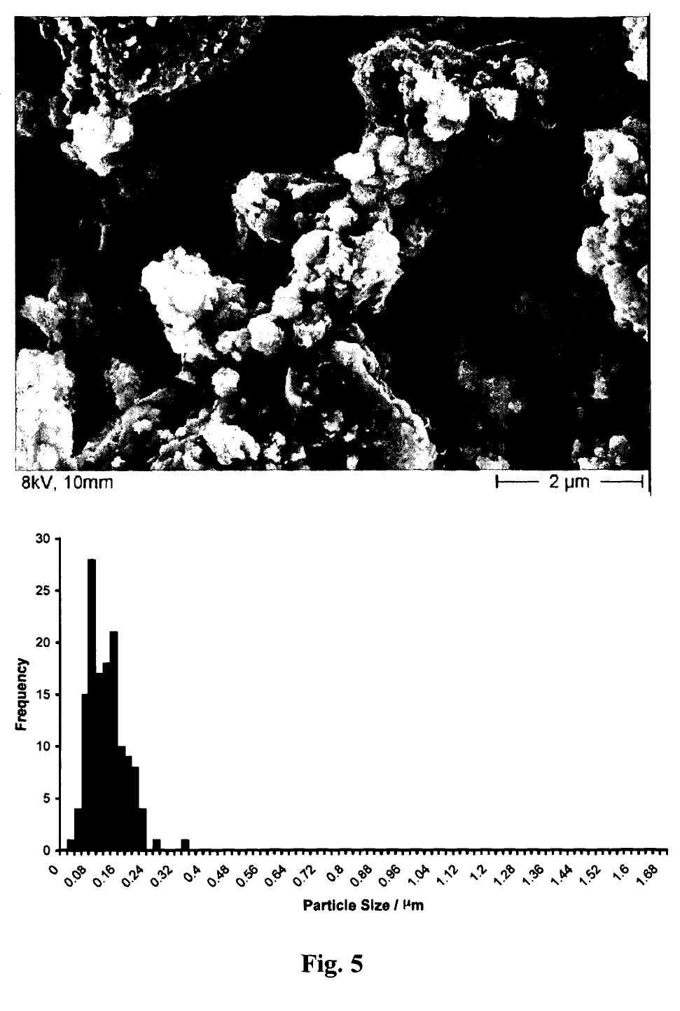

Scanning electron microscopy (SEM) was therefore also used to examine the surface morphology of the dry-milled silicon and recorded data are shown in FIGS. 1 to 5. All samples had a similar microstructure comprising of an agglomeration of approximately spherical particles with a significant size distribution, which could be weakly influenced by the milling conditions. It can be seen from FIGS. 1 to 3 that the mean particle size drops from 180 nm (FIGS. 1) to 158 nm (FIGS. 2), and to 133 nm (FIG. 3), as the milling time at 800 rpm rises from 15 minutes to 1 hour to 2 hours respectively. The size distribution also decreases (FIGS. 1 to 3). In contrast, the mean particle size was not much affected by milling speed; samples milled for two hours at speeds of 600 rpm (FIG. 4), 800 rpm (FIGS. 3) and 1000 rpm (FIG. 5) all had average particles sizes in the range 129-144 nm. However the size distributions became with increasingly narrower as the milling speed was increased (FIGS. 3 to 5). These particle sizes are significantly bigger than those calculated by XRD as noted above, suggesting that line broadening mechanisms apart from particle size effects are also operative. Since the fine particle aggregates were not visible in the starting material, it is apparent that the milling process must break the granular silicon into the nanoparticles observed, which however then reaggregate due to strong adhesive forces.

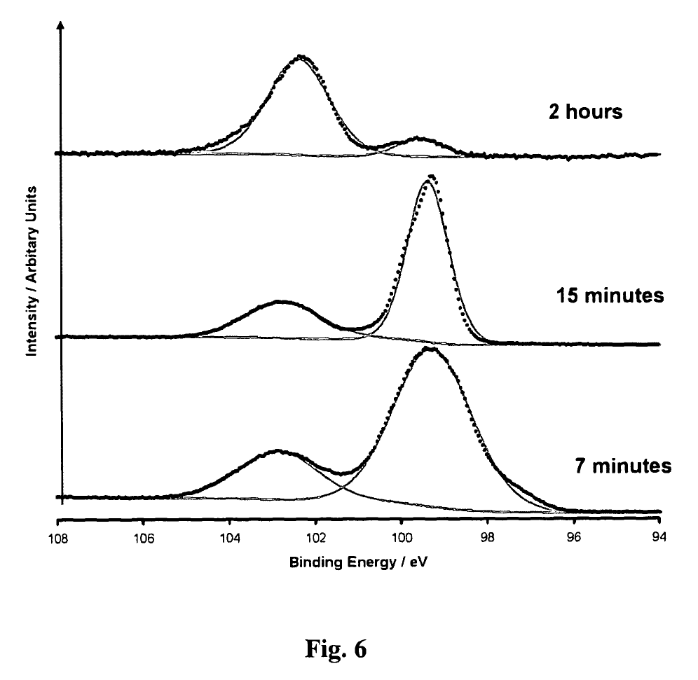

X-ray photoelectron spectroscopy (XPS) was used to analyze the surface of the milled silicon. Again only Si and O signals were seen and XPS spectra of the Si 2p region are shown in FIG. 6. XPS of the sample milled at 800 rpm for 2 hours revealed 2 Si 2p environments at binding energies of 99 and 103.5 eV corresponding to elemental silicon and SiO₂ respectively and an O 1 s ionisation at 530.4 eV (Grunthaner, F. J. et al. Journal of Vacuum Science & Technology, 16, 1443-1453 (1979); Pavlyak, F., Bertoti, I., Mohai, M., Biczo, I. & Giber, J. Surf. Interface Anal. 20, 221-227 (1993)). The ratio of the areas of the 2p peak at 103.5 eV and the O 1 s peak, taking into account empirically derived sensitivity factors is 1:2 which is also consistent with the presence of an SiO₂ phase. The ratio of the silicon: silica peak area was determined to be 1:6.8. Similar binding energies were observed for the samples milled for 7 minutes and 15 minutes except the silicon: silica ratios were 3.3:1 and 2.4:1 respectively, indicating an increase in the oxide content of the alloys with increasing milling time. If a core-shell model is adopted for the particles in the material, assuming an oxidized silica shell around a silicon core, then approximate oxide thicknesses of 3.5 nm, 0.7 nm and 0.6 nm are calculated from the spectra in FIG. 6. XPS carried out on a series of silicon powders milled for a constant time (2 hours) at varying speeds showed an increase in the oxidation of the samples also occurred with increasing milling speed. For comparison, XPS spectra of several commercial Si powders were recorded after storage in air. The samples had nominal particles sizes of 250, 44 and 0.1 μm. They showed variable oxide content, as judged from the Si 2p profiles, with calculated oxide thicknesses in the range 0.5-0.7 nm.

As expected, no reaction could be detected if these commercial Si samples were immersed in water in the temperature range 20-90° C., commensurate with the expected reactivity patterns of passivated Si. Hydrogen evolution could be observed if hot sodium hydroxide solutions were employed. Characteristically no hydrogen is observed during an initial phase, which we believe is associated with dissolution of the passivating oxide according to reaction (3):

SiO₂(s)+2NaOH (aq)→Na₂SiO₃ (aq)+H₂O (l) (3)

After this incubation period, hydrogen evolution then sets in according to reaction (1):

Si(s)+2NaOH (aq)+H₂O (l)→Na₂SiO₃ (aq)+2H₂ (g) (1)

with the reaction proceeding to completion in the order of 1 hour in the conditions employed.

In marked contrast, the milled Si samples do exhibit hydrogen evolution even in pure water below 100° C. FIG. 7 illustrates the hydrogen evolution profiles recorded at 90° C. for samples milled at 700 rpm for different times. The amount of hydrogen produced is expressed in terms of the yield (%), which is defined as the volume of hydrogen produced over the theoretical volume of hydrogen produced if all of the silicon is hydrolyzed according to reaction (2):

Si(s)+2 H₂O (l) SiO₂(s)+2 H₂ (g) (2)

A notable feature of all the hydrogen evolution profiles using the milled Si samples is the absence of an incubation period; hydrogen evolution occurred almost instantaneously upon addition of the silicon to the water, consistent with the lack of a passivating oxide layer which would cause reaction via reaction (3) rather than (2). Initially the rates of hydrogen production are high followed by a considerable decline in the reaction rate, with time. In all cases the hydrogen evolution eventually halted before reaction was completed, with yields between 36-64% depending on reaction conditions.

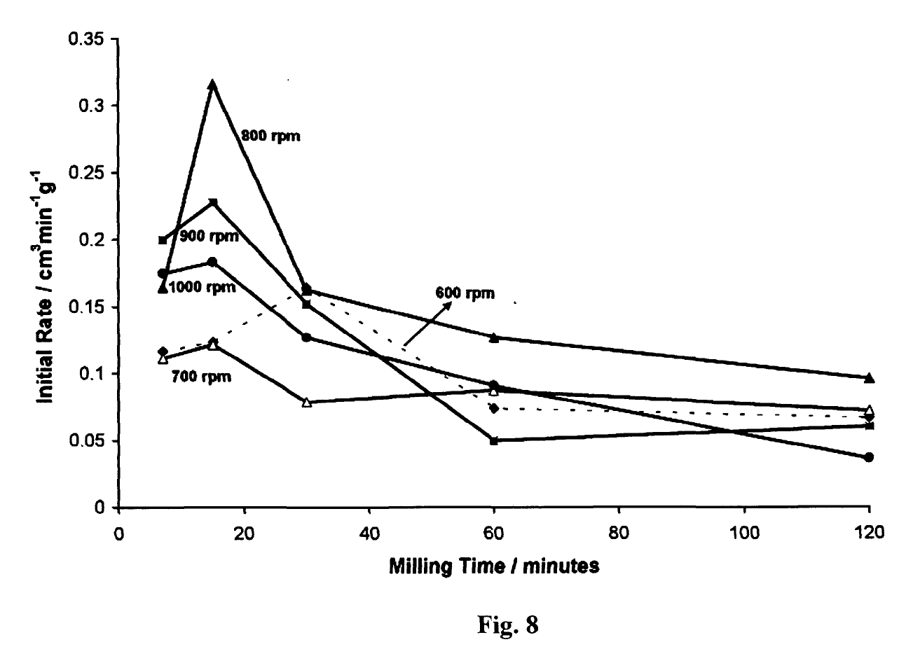

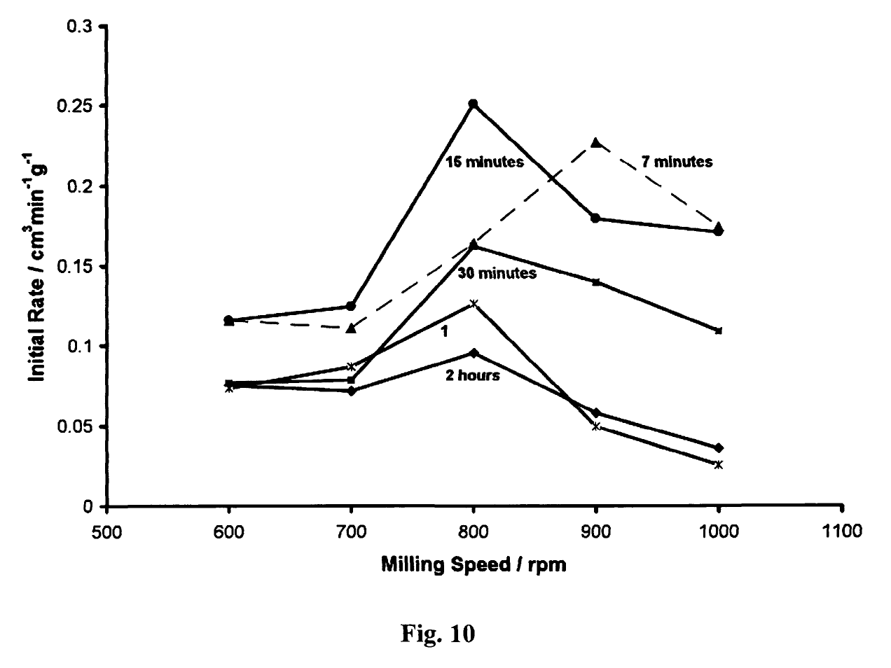

Significant hydrogen evolution rates and yields were seen over a reaction temperature range of 70-90° C. with the rate increasing with temperature according to an Arrehenius rate law with an activation energy of approximately 125 kJ mol⁻¹. Hydrogen evolution could even be detected at room temperature (21° C.), although the rate was at least two orders of magnitude slower than at the higher temperatures. The initial rate and overall yield varied quite significantly with milling conditions and data is shown in FIGS. 8 to 10. For a given milling speed, the rate and initial rate and yield typically increased for short milling times, whilst it decreased at long times. Similarly for a given milling time the initial rate rose as the milling speed was increased, then dropped off at higher speeds. Without wishing to be bound by theory, it is believed this is because there are two competing factors; as the milling time (and to a lesser extent the speed) increase, the particle size tends to drop so increasing reactivity, but this is counteracted by passivation by oxidation by contaminants in the nitrogen atmosphere. At longer milling times the latter effect is thought to dominate. At higher milling speeds, it was also notable that significant sample heating occurred, which would also be expected to increase the contamination rate. These hydrogen yields significantly exceed those reported previously for the hydrolysis of Mg, MgH₂, Al-based alloys and Na/SiO₂ composites with water.

The simplest model to describe the chemistry observed would involve as a starting point a pure silicon nanoparticle, which gradually becomes encapsulated with an oxide shell due to reaction (2) as the interaction proceeds. Clearly if yields of 36-64% are to be observed, as in these experiments, then this fraction of the silicon particle would need to be converted to silicon oxide before complete passivation occurs. For particle sizes of around 150 nm for example which SEM shows were typical, a 40% yield would correspond to the oxidation of the outermost 11 nm of the particle. This is extremely thick compared to the thermal oxide scales found on powdered Si after room temperature oxidation in the atmosphere, which as we note above is typically less than 1 nm for the commercial powders that were purchased. It is also noted that the milled samples when analysed by XPS seemed to have an oxide content not dissimilar to the commercial powders. Yet the commercial powders showed no evolution of hydrogen when immersed in water at temperatures up to 90° C., whereas the milled samples showed very significant yields. There are two important deductions to be made. Firstly, the corrosion film which forms at the heated silicon-water interface during reaction of the milled oxides must be far less passivating in nature than the natural oxides which form at the silicon-air interface. Secondly, as judged by their oxide content in XPS, the milled samples are much more reactive than the commercial samples purchased. At present it is not exactly clear why this should be so. Possibly the long lived oxide which forms under slow air oxidation is more impermeable than the oxides produced on the milled samples. Alternatively, due to the strong agglomeration seen for the “dry” samples, perhaps internal surfaces of the agglomerates are protected from significant oxidation.

These two aspects are believed to be important to the success of the process of the invention. If passivation as seen for commercial samples are seen, then particles oxidation limited to a depth of 1 nm would dramatically reduce the yield unless much more highly divided Si was used, which is likely to be pyrophoric. In addition, to preserve the milled samples, much more stringent preparation and storage conditions than the simple nitrogen atmospheres used here would have been required.

The inventors have therefore provided a practical demonstration of the feasibility of the silicon-water system, and have shown that it has the potential to function as a safe, efficient and economical local production source for hydrogen. System optimisation should be possible in order to improve evolution rates and yields in due course.

### Example 2

### Preparation of Nonpassivated Silicon by Wet Milling, and its Reaction With Water to Generate Hydrogen Gas

Silicon pieces were ball milled at speeds from 600 to 1000 rpm for periods between 2 to 30 minutes in the presence of acetonitrile under an inert atmosphere. The hydrolysis of the resulting nanoparticles with water was investigated so as to assess the potential of this route to supply hydrogen to fuel cells. The silicon particles had a microstructure comprising primarily of irregular shaped and sized shards, with spherical agglomerates also observed with increasing milling time. X-ray photoelectron spectroscopy showed that increasing the milling time resulted in a small increase in the oxygen content of the samples, whereas varying the milling speed had little effect. The silicon particles reacted instantaneously with water generating hydrogen, and the hydrolysis continued for a duration of 3-4 hours producing yields between 5.13 wt % and 9.54 wt %, with 2.99 wt % and 9.26 wt % respectively of the total yield generated within the first hour. These results compare favourably with those obtained for dry milled silicon nanoparticles (Example 1).

The inventors have demonstrated the feasibility of generating hydrogen via the hydrolysis of silicon particles (see Example 1). This was achieved by “dry” ball milling low surface silicon pieces in order to remove the surface oxide layer that would otherwise passivate the silicon preventing reaction with water. The resulting silicon particles reacted instantaneously with water generating hydrogen with initial rates between 0.12-0.32 cm³min⁻¹ g⁻¹, and the hydrolysis continued for a duration of 12 hours producing yields between 5.13 wt %-9.11 wt %. Although the hydrogen yields generated by some of the dry-milled silicon powders meet the DOE's 2015 requirements for hydrogen storage materials, it was still desirable to provide nonpassivated silicon particle with faster hydrolysis kinetics, in order further to enhance the practical applications of this approach. Low milling times (15-30 minutes) and speeds (600-800 rpm) of the dry-milled particles favoured high initial rates and hydrogen production yields. However, samples were subject to greater oxidation during prolonged dry-milling, which inhibited the hydrolysis despite the increased surface area of the silicon particles. Producing higher surface area particles whilst controlling the oxidation which occurs during the milling process would therefore enhance both the kinetics of the hydrolysis and the yield of hydrogen produced.

This Example describes how this can be achieved by addition of a solvent to the grinding process (“wet milling”). During wet milling the adsorption of solvent molecules onto the newly formed silicon surfaces lowers the surface energy, hence accelerating the milling. As such finer particles can be produced in shorter periods with less oxidation occurring during the process compared with dry milling. This Example details an investigation into hydrogen production through the hydrolysis of silicon nanoparticles produced by ball milling in the presence of acetonitrile. Milling time and milling speed were varied, and the particle surface area and initial level of oxidation have been found to be critical to good hydrogen production characteristics. The influence of the solvent in the milling process has been studied by comparison of this work with the work on dry milled silicon particles.

Milling Experiments

Ball milling was carried out in tempered steel vials which were loaded and unloaded inside a nitrogen glove box. Silicon pieces (99.95%, 2.5 g, 88.9 mmol) were placed into the steel vials containing 5 mm diameter steel balls (41.6 g) corresponding to a silicon: ball ratio of 1:17. Dry acetonitrile was then added to the vials. There were slight variations in the volume of acetonitrile added to ensure that all voids were filled and the steel balls were just covered with solvent. Samples were milled for periods of 2, 3, 5 and 7 minutes at speeds ranging from 600-1000 rpm in 100 rpm increments using a Pulverisette 7 premium line ball mill. In addition a series of samples were prepared by milling for extended periods of 10, 15 and 30 minutes at 900 rpm. After milling the samples were returned to the glove box were the solvent was removed in vacuo and the samples were stored under nitrogen until required.

Hydrolysis Experiments

The hydrolysis reactions were carried out in a 100 cm³ glass reactor with three openings, one for the addition of the milled silicon powder to the heated water, one for monitoring the temperature and the other one for use as a hydrogen exhaust. The reactor containing water (60 cm³, 3.3 mol) was heated with a water bath to 90° C. The silicon powder (0.3 g, 10.7 mmol) was packed into a gelatine capsule (100%, Agar) inside the glove box in order to allow transfer of the sample to the reactor flask without exposure to air. Once a constant temperature was maintained the silicon powder was added to the reactor flask. A magnetic stirrer agitated the solution throughout the course of the reaction. The hydrogen produced by the hydrolysis of the milled silicon was passed through a water bath at ambient temperature via a Tygon tube of length 40 cm and internal diameter of 3 mm in order to condense any water vapour and was collected in an inverted burette. Gas chromatography confirmed that the evolved gas was indeed hydrogen. A series of experiments were also conducted at temperatures of 70° C. and 80° C. By recording the volume of hydrogen evolved as a function of time the initial rates and reaction yields were determined.

Physical Characterisation

Powder X-ray Diffraction (XRD) patterns were recorded on a Panalytical instrument using monochromated Cu K_{α1} radiation (λ=1.5046 Å). Scanning electron microscopy (SEM) was carried out on a field emission JEOL 840F instrument at an accelerating voltage of 8 KV. Energy dispersive X-ray analysis (EDX) was performed on an Oxford instruments 840A system at an accelerating voltage of 20 kV using Inca Energy analytical software. The specific surface area of the powders was measured by N₂ adsorption (multipoint BET) using a Sorptomatic 1990 automated gas sorption system. X-ray photoelectron spectroscopy (XPS) measurements were carried out on a VG ESALAB 220i XL instrument using focussed (300 μm spot) monochromatic Al—K_{α} X-ray radiation at a pass energy of 20 eV. Scans were acquired with steps of 50 meV. A flood gun was used to control charging and the binding energies were referenced to surface elemental carbon at 284.6 eV. XPS data was fitted using the CasaXPS program.

Results and Discussion

X-ray photoelectron spectroscopy (XPS) was used to analyze the surface of the wet milled silicon. XPS of the sample milled at 900 rpm for 30 minutes revealed two Si 2p_{3/2} environments at binding energies of 99 and 103.5 eV corresponding to elemental silicon and SiO₂ respectively and an O 1s ionisation at 530.4 eV. The ratio of the areas of the Si 2p peak at 103.5 eV and the O 1s peak, taking into account empirically derived sensitivity factors is 1:2 thus all of the oxygen is accounted for by SiO₂. The ratio of the silicon:silica peak was determined to be 3.1:1. Similar binding energies were observed for the samples milled for 2, 5 and 7 minutes and the silicon: silica ratios were 6.9:1, 5.7:1 and 5.1:1 respectively, indicating a small increase in the oxide content of the samples with increasing milling time. Compared with silicon powders prepared by dry milling for equivalent periods the oxide content of these samples is considerably lower, indicating that the adsorption of the solvent onto the newly formed silicon surfaces suppresses the oxidation which occurs during the milling process. XPS carried out on a series of silicon powders wet milled for a constant time (5 minutes) showed very little variation in the oxide content of the samples with increasing milling speed. As expected the surface of the silicon powders following hydrolysis were comprised entirely of SiO₂.

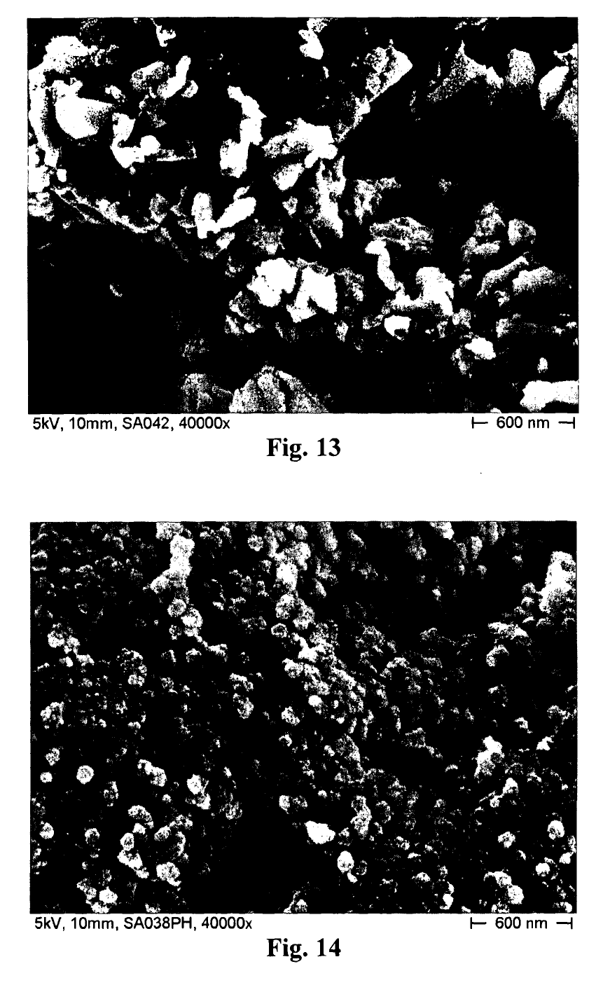

Scanning electron microscopy (SEM) was used to examine the surface morphology of the wet milled silicon. As shown in FIG. 13, the samples had a morphology comprising of irregular sized and shaped shards, typical of ball milled materials. This is strikingly different to the morphology observed in samples after hydrolysis, shown in FIG. 14, which resembled an agglomeration of spherical particles. Furthermore, samples milled for extended periods showed an intermediate morphology, consisting of irregular shards with some spherical agglomerates on their surfaces. Thus, it appears that the irregular shards might correspond to unoxidised silicon particles, and the spherical agglomerate microstructure is a consequence of an oxidized surface. Interestingly, all samples prepared by dry milling showed the spherical agglomerate microstructure indicating that the surface underwent significant oxidation during the milling process. This is consistent with the XPS data which showed that dry milled samples showed greater oxidation than samples wet milled for equivalent periods. Therefore it is not only the shorter milling times required for wet milling that limits the oxidation of the silicon but also the adsorption of the acetonitrile onto its surface.

Hydrolysis Experiments.

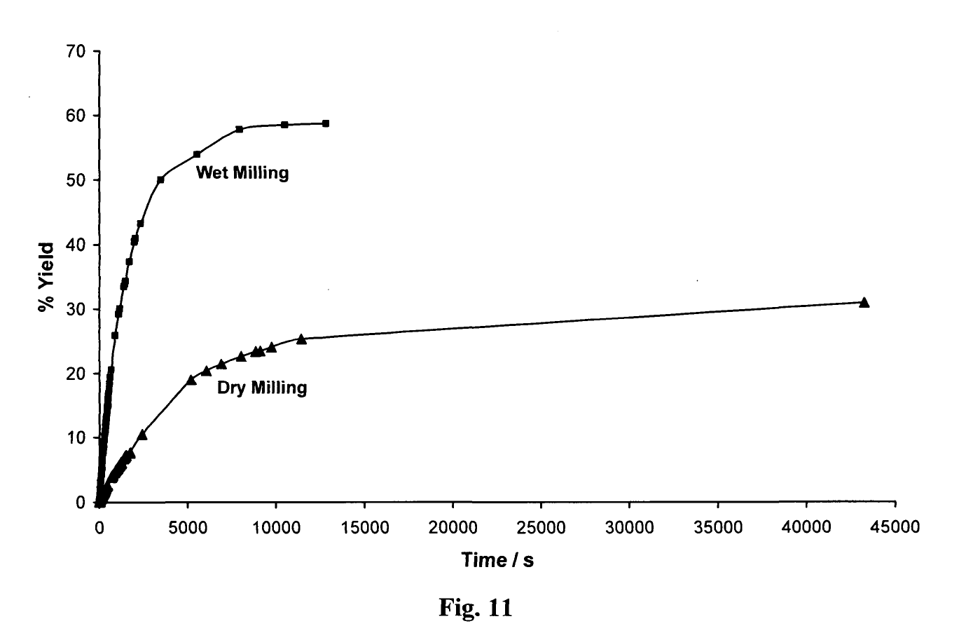

FIG. 11 shows a comparison of the hydrogen evolution profiles for samples produced by dry and wet milling. The samples were milled for 7 minutes at 700 rpm and the hydrogen evolution profiles were recorded at 90° C. The amount of hydrogen produced has been expressed in terms of the yield (%), which is defined as the volume of hydrogen produced over the theoretical volume of hydrogen produced if all of the silicon is hydrolyzed.

There are some notable differences between the hydrogen evolution profiles of the dry and wet milled samples. The wet milled sample has a significantly higher hydrogen production rate compared to the dry milled sample as well as producing a much greater yield of hydrogen. Although both samples show a decline in the rate of hydrogen evolved, following an initial rapid rate, which is ascribed to the passivation of the silicon by the formation of an oxide layer, the initial rapid rate continues for a much longer period in wet milled sample. Consequently the overall duration of the hydrolysis reaction varied, in the case of the wet milled sample hydrogen evolution proceeded for around 3½ hours with 50% of the theoretical yield of hydrogen produced during the first hour of the reaction, whereas for the dry milled sample only 13% of the total yield was produced in the first hour and the reaction continued for 12 hours.

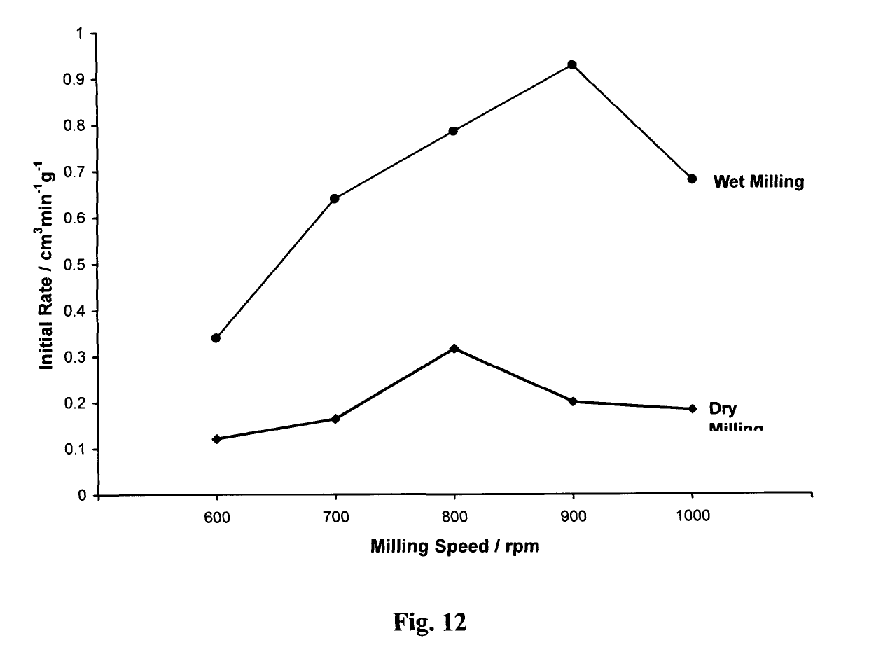

FIG. 12 shows a comparison of the initial hydrogen production rates of the dry and wet milled samples milled for 7 minutes at varying speeds. The initial rates were determined by measuring the gradient of the linear portion of the hydrogen evolution profiles. In all cases the initial rates of the wet milled samples significantly exceed those of the dry milled counterparts. During wet milling, the adsorption of solvent onto the newly-formed silicon surfaces lowers the surface energy enhancing the milling process and hence producing finer particles in the same time period. Furthermore, the adsorption of solvent onto the silicon surface inhibits the oxidation of the silicon particles that occurs during the milling process. The latter also accounts for the higher optimum milling speed of the wet milled series.

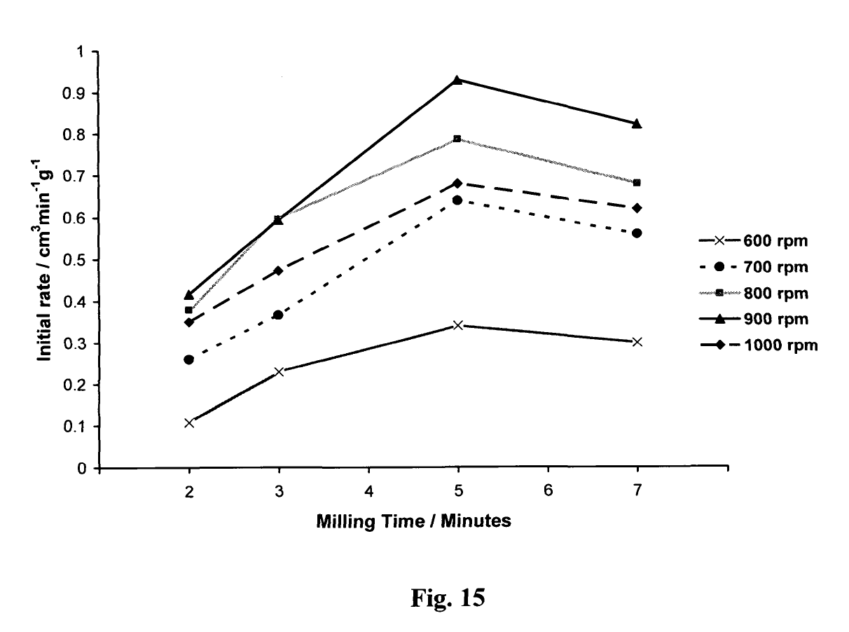

FIG. 15 shows the variation in the initial hydrogen production rate at 90° C., as a function of milling time for the wet milled samples milled at different speeds. All samples show an increase in their initial rate upon increasing the milling time from 2 to 5 minutes, with the maximum rate occurring at 5 minutes (0.34-0.93 cm³min⁻¹ g⁻¹). Further increasing the milling time to 7 minutes resulted in a slight decline in the rate.

Two processes occur upon increasing the milling time; an increase in the specific surface area of the milled silicon powders which results in an increase in the rate of hydrogen evolution and an increase in the oxide thickness which lowers the rate. These competing factors are thought to give rise to the optimum milling time. The increase in the initial rate from 2-5 minutes suggests that for the lowest milling times particle size is the more dominant factor in determining the initial rate, whereas with a milling time of 7 minutes the rate is somewhat inhibited by the increased oxidation of the samples.

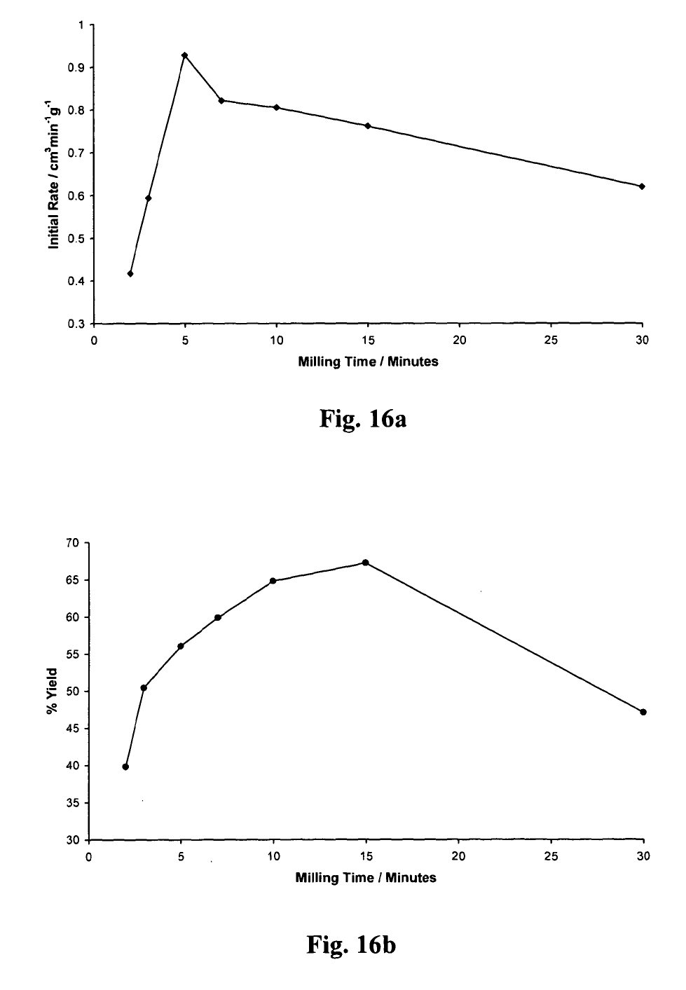

These initial hydrogen production rates are far in excess of those attained for the dry milled counterparts despite the significantly shorter intervals (2-7 minutes). In the equivalent time periods the kinetics of the hydrolysis of the dry milled samples was markedly limited by their small surface area. In wet milling however, the adsorption of solvent onto the surface of the newly formed silicon surfaces lowers the surface energy enhancing the milling process and hence reducing the time required to produce fine particles. These lower milling times also minimise the oxidation which occurs during the milling process. The dry milled samples however did show a similar variation in their initial rate with milling time, although the decline in the rate which occurred with longer milling times was far greater than for the wet milled samples. This difference may be due to the considerably shorter milling times the later were subject to. A series of further samples were prepared at 900 rpm for extended milling times (10, 15 and 30 minutes) in order to provide a better comparison with the dry milled samples. FIGS. 16a and 16b show the variation in the initial rate and yield of hydrogen produced respectively. For milling times in the range 7-15 minutes there is little variation in the initial rate (0.823-0.763), however increasing the milling time to 30 minutes results in a small decrease in the rate (0.621), albeit a far less substantial one compared with the dry milled samples in the same time period. These results coupled with the XPS data indicate that the oxidation that occurs during the milling process is limited by the adsorption of the solvent onto the surface of the silicon as well as by the lower times required for wet milling. Interestingly, the yield of hydrogen produced continues to increase with milling time, maximising at 67% for the sample milled for 15 minutes. Because the presence of the solvent suppresses oxidation of the silicon particles, the increase in the surface area of the silicon particles during the longer milling times more than compensates for the increase in their oxidation resulting in greater yields of hydrogen. Increasing the milling time further resulted in a decrease in the yield. Overall for samples milled at 900 rpm a milling time of 5 minutes produced the greatest rate of hydrogen production, whereas the sampled milled for 15 minutes had the best combination of rate and yield.

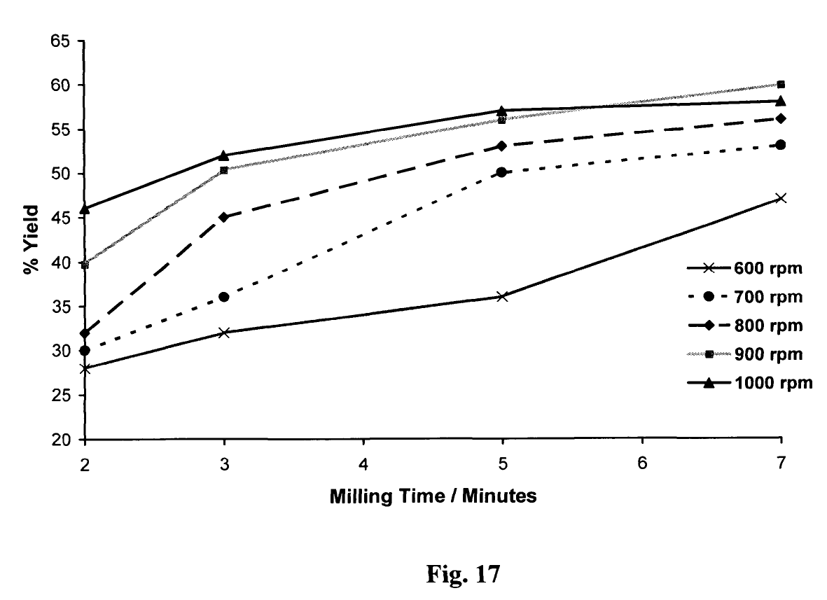

A steady increase in the hydrogen yield was observed with increasing milling (2-7 minutes) time for all milling speeds (as shown in FIG. 17) which is consistent with the increase in the surface area of the silicon particles. Although the maximum yield attained (60%) was similar to that for the dry milled samples (57%), overall the yields for wet milled samples were greater and the kinetics of the hydrolysis were significantly higher. Furthermore the dry milled samples showed a rapid decline in the yield at extended milling times. The shorter milling times required for wet milling and the suppression of oxidation by the adsorbed solvent also accounts for this difference.

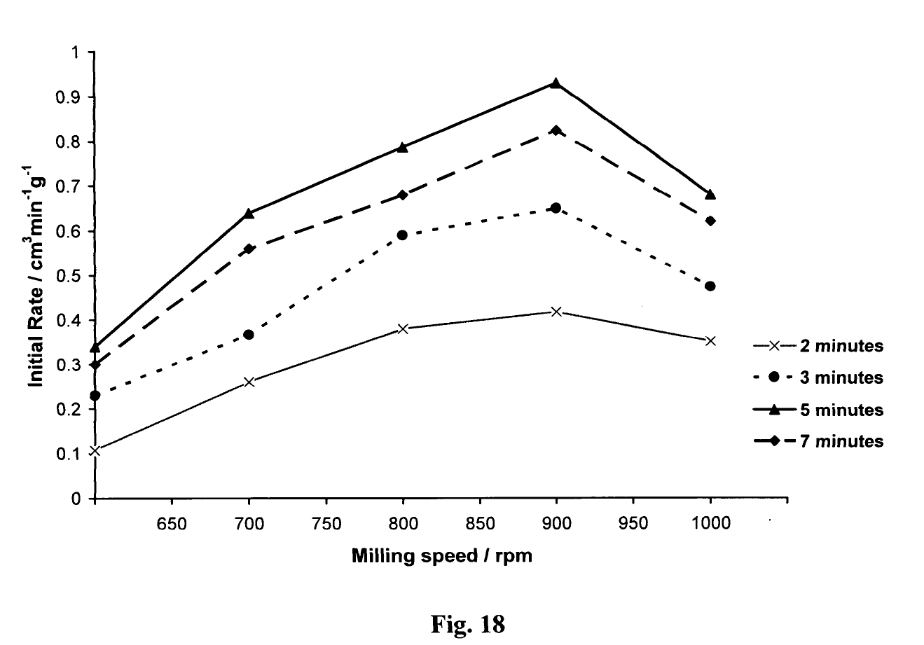

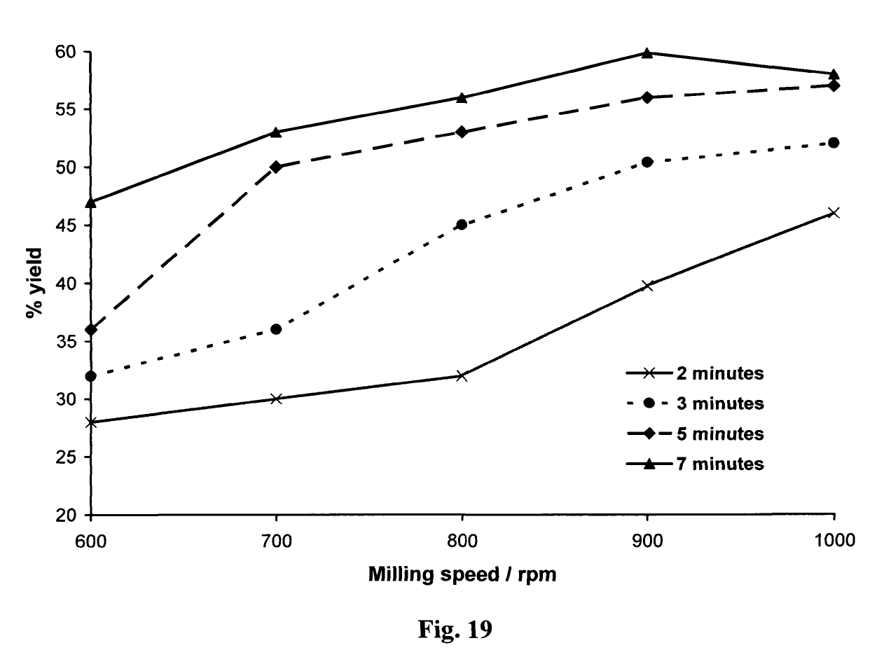

FIGS. 18 and 19 show comparisons of the initial rates of hydrogen production and total yield of hydrogen produced respectively for samples wet-milled at different speeds. For all milling times, the initial rate increases upon increasing the speed from 600-900 rpm, with the maximum rate occurring at 900 rpm. Further increasing the speed to 1000 rpm resulted in a small decrease in the rate. The yield of hydrogen produced showed a systematic increase with speed at all milling times. These trends are consistent with the BET and XPS data which show a increase in surface area with milling speed and little variation in the oxide content of the samples, particularly for low milling times. Conversely the initial rate and the total yield of hydrogen produced by the dry milled samples was inhibited by the increased oxidation of the silicon powders at high milling speedsin spite of their greater surface area.

Six of the wet milled samples had hydrogen yields greater than 9.0 wt % and specific energies exceeding 10.8 MJKg ⁻¹ and therefore meet the DOE's 2015 targets for a hydrogen storage material. Samples prepared by wet milling for 10 and 15 minutes at 900 rpm produced these hydrogen yields within the first hour of hydrolysis. In contrast only two of the dry milled samples fulfilled these requirements. Furthermore the hydrogen production rates were much slower and the reaction times considerably longer than for wet milled samples. These hydrogen yields significantly exceed those reported for the hydrolysis of Mg, MgH₂, Al-based alloys and Na/SiO₂ composite with water.

Comparison With Base

A series of preliminary experiments were carried out on the hydrolysis of silicon powders with aqueous sodium hydroxide. Three silicon powders with particle sizes of 250, 44 and 0.1 μm were investigated; these were purchased from Sigma Aldrich and were stored and manipulated in air. The silicon powders did not hydrolyze with water, however they reacted with sodium hydroxide producing hydrogen and sodium silicate, following an induction period. The rate of the hydrolysis increased with temperature, concentration of sodium hydroxide and decreasing particle size. Compared with the hydrolysis of dry milled silicon particles with water, far greater yields of hydrogen were generated, with the reaction often nearing completion under 2 hours. Whereas with water the rate of hydrolysis is significantly reduced due to the passivation of the silicon particles by the formation of the oxide layer, the oxide layer is dissolved by the sodium hydroxide enabling continued hydrogen production and hence greater hydrogen production rates and yields. However, as sodium hydroxide is extremely corrosive, its use would be undesirable in practical applications of silicon hydrolysis (in situ hydrogen production for fuel cells).

Although the oxide layer is removed during milling and fresh silicon surfaces are created, which can then be hydrolysed with pure water, during dry milling significant oxidation of the silicon particles occurs hindering the reaction. In contrast during wet milling the presence of the solvent suppresses the oxidation of the silicon particles resulting in initial hydrogen production rates comparable to those attained with sodium hydroxide. The passivation of the silicon particles with the oxide layer during the hydrolysis prevents the reaction going to completion, nevertheless relative to dry milled silicon powders a greater number of the samples have hydrogen yields which meet the DOE's 2015 targets and the reaction times have been significantly improved. Furthermore because lower times are required for wet milling, it is more suited for use in practical applications than dry milling as ball milling is an extremely energy intensive process.

Conclusion

The addition of solvent to the ball milling of silicon produces nanoparticles which exhibit significantly enhanced rates of hydrolysis and improved hydrogen yields compared with silicon nanoparticles prepared by dry milling. The adsorption of solvent onto the newly formed silicon surfaces lowers the surface energy and accelerates the milling process hence the time required to produce high surface area particles is considerably reduced. Furthermore the adsorbtion of solvent suppresses the oxidation of silicon particles that would otherwise inhibit the hydrolysis.

Wet milled silicon particles reacted instantaneously with water generating hydrogen with initial rates ranging from 0.34-0.93 cm³min⁻¹ g⁻¹, the hydrolysis of the silicon continued for a duration of 3-4 hours resulting in total yields between 5.13 wt % and 9.54 wt %, which correspond to specific enthalpies of 6.76 MJKg⁻¹and 12.59 MJKg⁻¹ respectively. Six of the wet milled powders fulfilled the DOE's 2015 requirements for hydrogen storage materials and two of these samples produced the required yield during the first hour of hydrolysis.

Whilst dry milling demonstrated the feasibility of the silicon-enabled hydrogen fuel economy and produced samples which met the DOE's 2015 requirements for hydrogen storage materials, the addition of solvent to the milling process is a significant step towards enhancing the kinetics of the hydrolysis and the yield of hydrogen produced, and therefore the practical applicability of this approach.

### Example 3

### Preparation of Nonpassivated Silicon by Dry Milling, and its Characterisation by Synchrotron X-Ray Diffraction

Si produced by the dry milling process as described in Example 1 was characterised by X-ray diffraction to gain a measure of the crystallographic disorder present in the product. Typical X-ray diffraction data for 3 samples of cubic silicon collected on beam line I11 at the Diamond (synchrotron) light source (λ=0.83 Å) are shown in FIG. 20. The plot in FIG. 20 show samples milled at 800 rpm for 0.25 hours (lower line), 0.5 hours (middle line), and 1 hour (upper line). A general increase in the width of the Bragg peaks was observed with increasing milling time, and this is consistent with a decrease in particle size coupled with the creation of crystallographic disorder. An additional peak, not associated with the structure of cubic (Fd-3m) silicon can be observed at ˜14.5° 2-theta. This peak, most clearly seen in the data for the sample milled for 0.25 hrs (under which milling regime the material is most crystalline), is of an unusual shape commonly associated with the presence of stacking defects within the structure. The inset of FIG. 20 shows an expansion of this peak (highlighted by the box in the inset). While it may appear that the feature disappears with extended milling time, the increase in diffraction background and [111] peak breadth due to creation of non-crystalline material and smaller particles, respectively, by the milling process act to hide the intensity of this feature. That this feature remains visible even with the significant increase in background intensity suggests it increases in intensity with milling time, which corresponds to an increase in stacking fault density with prolonged milling. It is therefore indicated that the milling process creates significant stacking fault defects within the silicon structure.

1. A process for producing nonpassivated silicon, which process comprises providing a sample of silicon and, under inert conditions, reducing the mean particle size of the sample by applying a mechanical force to the sample.

2-3. (canceled)

4. A process according to claim 1 wherein the step of reducing the mean particle size of the sample is performed under an inert atmosphere and/or in an inert solvent.

5-8. (canceled)

9. A process according to claim 1 wherein the step of reducing the mean particle size in the sample causes the mean particle size to be reduced to a particle size of less than or equal to 200 nm.

10. A process according to claim 1 wherein said silicon in said sample bears an outer layer of silicon dioxide on at least part of a surface thereof, wherein said outer layer of silicon dioxide has a first thickness, and wherein the step of reducing the mean particle size in the sample causes the average thickness of said outer layer of silicon dioxide to decrease from said first thickness to a second thickness, wherein the second thickness is less than or equal to 3.5 nm

11. A process according claim 1 wherein the step of reducing the mean particle size in the sample causes the ratio of Si to SiO₂ on the surface of said sample, as measured by X-ray photoelectron spectroscopy, to increase from a first ratio to a second ratio, wherein the second ratio is greater than the first ratio, and wherein the second ratio is at least 3:1.

12. A process according to claim 1 wherein the step of reducing the mean particle size in the sample causes the reactivity of the sample, with pH-neutral water at 90° C. to produce hydrogen, to increase from a first initial rate of hydrogen gas evolution to a second initial rate of hydrogen gas evolution, wherein the second rate is greater than the first rate, and wherein the second rate is at least 0.30 cm³ min⁻¹ g⁻¹.

13. A process according to claim 1 wherein the step of reducing the mean particle size in the sample of silicon causes the yield of hydrogen produced, when reacting said silicon with pH-neutral water at 90° C., to increase from a first yield to a second yield, wherein the second yield is greater than the first yield, and wherein the second yield is at least 25%.

14. A process according to claim 1 wherein the step of reducing the mean particle size in the sample of silicon causes the yield of hydrogen produced, when reacting said silicon with pH-neutral water at 90° C., to increase from a first amount to a second amount, wherein the second amount is greater than the first amount, and wherein the second amount is at least 5 weight % hydrogen.

15. (canceled)

16. A process according to claim 1 wherein said silicon in said sample comprises crystalline silicon, and wherein the step of reducing the mean particle size in the sample causes an increase in the crystallographic disorder in said crystalline silicon.

17. A process according to claim 1 wherein said silicon in said sample comprises crystalline silicon, and wherein the step of reducing the mean particle size in the sample increases the number of stacking fault defects in said crystalline silicon.

18. A process according to claim 16 wherein the crystallographic disorder is characterised by an X-ray diffraction peak at a two theta value between 14.0° and 14.8°, when a radiation wavelength of 0.83 angstroms is used.

19. A process according to any one of the preceding claims 1 wherein said silicon in said sample comprises cubic (Fd-3m) crystalline silicon having characteristic X-ray diffraction peaks at two theta values of 15°±0.5°, 25°±0.5°, 29°±0.5°, 36°±0.5°, 38°±0.5°, 44°±0.5° and 47°±0.5° when a radiation wavelength of 0.83 angstroms is used, and wherein said step of reducing the mean particle size in the sample causes the crystallographic disorder in said crystalline silicon to increase, wherein the resulting nonpassivated silicon has said characteristic X-ray diffraction peaks at two theta values of 15°±0.5°, 25°±0.5°, 29°±0.5°, 36°±0.5°, 38°±0.5°, 44°±0.5° and 47°±0.5° and an additional peak at a two theta value of from 14.0° to 14.8°, when a radiation wavelength of 0.83 angstroms is used.

20. A process according to claim 1 wherein the nonpassivated silicon has an X-ray diffraction pattern substantially as shown in FIG. 20.

21. A process according to claim 1 wherein the step of reducing the mean particle size of the sample comprises milling the sample.

22. A process according to claim 1 wherein the step of reducing the mean particle size of the sample comprises milling the sample using a ball mill.

23-24. (canceled)

25. A process according to claim 21 wherein the milling speed is from 600 to 1000 rpm.

26. (canceled)

27. A process according to claim 21 wherein the sample is milled for a duration of from 2 minutes to 3 hours.

28. A process according to claim 21 wherein the sample is milled in an inert atmosphere, in the absence of solvent, for a duration of from 5 minutes to 80 minutes.

29. A process according to claim 21 wherein the sample is milled in an inert solvent, for a duration of from 2 minutes to 40 minutes.

30. A process according to claim 1 wherein the sample of silicon provided comprises granular silicon or coarse silicon particles.

31-32. (canceled)

33. A process according to claim 1 which further comprises recovering said nonpassivated silicon, under inert conditions.

34. (canceled)

35. A process according to claim 33 which further comprises coating said nonpassivated silicon with an organic coating, to form one or more encapsulates which comprise nonpassivated silicon within an organic coating.

36. A process according to claim 35 wherein the organic coating is suitable for preventing or reducing exposure of the nonpassivated silicon to air and wherein the organic coating is capable of dissolving, degrading or melting away upon exposure to water having a temperature less than or equal to 100° C. and a pH of from 5 to 9.

37. (canceled)

38. A process according to claim 35 wherein the organic coating comprises gelatine.

39. A composition which comprises nonpassivated silicon.

40. A composition according to claim 39 wherein the nonpassivated silicon is capable of reacting with water, at a pH of 7, and at a temperature of 90° C., to produce hydrogen, wherein the initial rate of hydrogen gas evolution is at least 0.10 cm³ min⁻¹ g⁻¹.

41. (canceled)

42. A composition according to claim 39 wherein the nonpassivated silicon is capable of reacting with water, at a pH of 7, and at a temperature of 90° C., to produce hydrogen, wherein the yield of hydrogen produced is at least 25%.

43. (canceled)

44. A composition according to claim 39 wherein the nonpassivated silicon is capable of reacting with water, at a pH of 7, and at a temperature of 90° C., to produce at least 5 weight % hydrogen based on the weight of said nonpassivated silicon.

45-46. (canceled)

47. A composition according to claim 39 wherein the nonpassivated silicon has a mean particle size of less than or equal to 300 nm.

48. A composition according to claim 39 wherein the nonpassivated silicon has a mean particle size in the range of from 50 nm to 200 nm, wherein 90% of the particles have a particle size of less than 500 nm.

49. (canceled)

50. A composition according to claim 39 wherein the ratio of Si atoms to SiO₂ moieties on the surface of said nonpassivated silicon, as measured by X-ray photoelectron spectroscopy, is at least 2:1.

51. A composition according to claim 39 wherein the nonpassivated silicon bears an outer layer of silicon dioxide, on at least part of a surface thereof, which layer has an average thickness of less than or equal to 3.5 nm.

52-53. (canceled)

54. A composition according to claim 39 wherein the nonpassivated silicon comprises crystalline silicon, wherein the crystalline silicon comprises stacking fault defects.

55. A composition according to claim 39 wherein the nonpassivated silicon comprises cubic (Fd3m) silicon, wherein the cubic (Fd3m) silicon comprises crystallographic disorder characterised by an X-ray diffraction peak at a two theta value of from 14.0° to 14.8° when a radiation wavelength of 0.83 angstroms is used.

56. A composition according to claim 39 wherein the nonpassivated silicon comprises crystalline silicon having characteristic X-ray diffraction peaks at two theta values of 15°±0.5°, 25°±0.5°, 29°±0.5°, 36°±0.5°, 38°±0.5°, 44°±0.5° and 47°±0.5° and an additional peak at a two theta value of from 14.0° to 14.8° when a radiation wavelength of 0.83 angstroms is used.

57. A composition according to claim 39 wherein the nonpassivated silicon comprises crystalline silicon having an X-ray diffraction pattern substantially as shown in FIG. 20.

58. A composition according to claim 39 which comprises one or more encapsulates, wherein the one or more encapsulates comprise said nonpassivated silicon encapsulated within an organic coating.

59. A composition according to claim 58 wherein the organic coating is suitable for preventing or reducing exposure of the nonpassivated silicon to air and wherein the organic coating is capable of dissolving, degrading or melting away upon exposure to water having a temperature less than or equal to 100° C. and a pH of from 5 to 9.

60. A composition according to claim 58 wherein the organic coating comprises gelatine.

61. Nonpassivated silicon which is obtainable by a process as defined in claims 1.

62-63. (canceled)

64. A pellet for generating hydrogen, the pellet comprising nonpassivated silicon encapsulated within an organic coating.

65. (canceled)

66. A pellet according to claim 64, wherein the organic coating is suitable for preventing or reducing exposure of the nonpassivated silicon to air, and wherein the organic coating is capable of dissolving, degrading or melting away upon exposure to water having a temperature less than or equal to 100° C. and a pH of from 5 to 9.

67. (canceled)

68. A pellet according to claim 64 wherein the organic coating comprises gelatine.

69. A process for producing hydrogen, which process comprises contacting water with nonpassivated silicon, thereby producing hydrogen by hydrolysis of said silicon.

70-82. (canceled)

83. A process according to claim 69, wherein the nonpassivated silicon is provided in the form of one or more encapsulates, wherein the one or more encapsulates comprise said nonpassivated silicon within an organic coating, and wherein the process comprises contacting said water with the one or more encapsulates and allowing the organic coating to dissolve, degrade or melt away, thereby contacting the water with the nonpassivated silicon.

84. A process according to claim 83 wherein the organic coating comprises gelatine.

85. (canceled)

86. A process according to claim 69 wherein the nonpassivated silicon comprises nanoparticles of silicon, wherein the nanoparticles of silicon are obtainable by reducing a silicon salt in the presence of an organic solvent; by reducing a silicon salt contained within micelles; by plasma synthesis; by ultrasonic dispersion of electrochemically etched silicon; by laser-driven pyrolysis of silane; or by synthesis in supercritical fluids.

87-90. (canceled)
